(19) United States
(12) Patent Application Publication
(10) Pub. No.: US 2023/0415612 A1
(43) Pub. Date: Dec. 28, 2023

(54) ELECTRIC VEHICLE THERMAL MANAGEMENT CONTROL SYSTEMS AND METHODS FOR MANAGING BATTERY THERMAL LOADS

(71) Applicant: Nikola Corporation, Phoenix, AZ (US)

(72) Inventors: Brandon Christopher Dunn, Gilbert, AZ (US); Behrooz Karimi, Phoenix, AZ (US); Akshit Markan, Tempe, AZ (US)

(21) Appl. No.: 18/325,331

(22) Filed: May 30, 2023

Related U.S. Application Data
(60) Provisional application No. 63/494,061, filed on Apr. 4, 2023.
(60) Provisional application No. 63/366,021, filed on Jun. 8, 2022.

(51) Int. Cl. B60L 58/26

(52) U.S. Cl. CPC B60L 58/26; B60L 2240/545

(57) ABSTRACT

The present disclosure provides a method of managing thermal loads in an electric vehicle and controlling various electronic components of a thermal management system. The method may comprise heating a battery coolant of a battery coolant loop utilizing waste heat from a battery to form a heated battery coolant, heating a refrigerant of a battery refrigeration loop by exchanging heat with the heated battery coolant, and measuring refrigerant temperature(s) and pressure(s) at an output of a chiller. The measured temperature(s) and pressure(s) may be utilized by the thermal management system as feedback signals for performing a proportional-integral-derivative control to compute an electronic expansion valve position command. Battery temperature(s) and/or battery coolant temperature(s) may be measured and utilized by the thermal management system as feedback signals for computing a pump speed command and performing a proportional-integral-derivative control to compute a compressor speed command and a condenser fan speed command.

### CROSS-REFERENCE TO RELATED APPLICATIONS

This application claims priority to, and the benefit of, U.S. Provisional Patent Application Ser. No. 63/494,061 filed on Apr. 4, 2023 entitled “Electric Vehicle Thermal Management Control Systems and Methods for Managing Battery Thermal Loads.” This application also claims priority to, and the benefit of, U.S. Provisional Patent Application Ser. No. 63/366,021 filed on Jun. 8, 2022 entitled “Electric Vehicle Thermal Management Control Systems and Methods for Managing Battery Thermal Loads.” The disclosures of each of the foregoing applications are incorporated herein by reference in their entireties, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to thermal management systems, and more particularly, to thermal management control systems for electric vehicles.

### BACKGROUND

Fuel cell electric vehicles (FCEVs) utilize multiple fuel cells, combined in what is known as a fuel cell stack, to generate an electric current to power one or more system components to operate the vehicle. For example, the electric current generated by the fuel cell stack may be used to charge an onboard battery system that may be used to power one or more electric motors to drive the vehicle's wheels as well as power multiple other electrically operated systems of the vehicle. Similarly, modern battery electric vehicles (BEVs) also include a battery system capable of storing energy to be used to power the electric vehicle. For example, electric current provided to the battery system by an electrical grid may be used to power one or more electric motors to drive the vehicle's wheels as well as power other electrically operated systems of the vehicle. In heavy-duty electric commercial vehicles (FCEVs and BEVs), battery requirements (volume, mass, capacity, power output, etc.) may be substantial due to the size and weight of the vehicle and weight of the trailer and cargo to be delivered. Accordingly, systems and methods that efficiently cool these battery systems in order to maximize battery system lifespan and performance are desirable.

### SUMMARY

A method of managing thermal loads in an electric vehicle may comprise heating, utilizing waste heat from a battery, a battery coolant of a battery coolant loop to form a heated battery coolant, heating a refrigerant of a battery refrigeration loop by exchanging heat with the heated battery coolant, measuring a first refrigerant temperature located at an outlet of a first chiller, measuring a first refrigerant pressure located at the outlet of the first chiller, and controlling a position of a first electronic expansion valve based upon the first refrigerant temperature and the first refrigerant pressure.

In various embodiments, the first electronic expansion valve is located at an inlet of the first chiller. The method may further comprise passing the refrigerant through the first chiller to exchange heat with the heated battery coolant, the first chiller is thermally coupled between the battery coolant loop and the battery refrigeration loop. The method may further comprise compressing the refrigerant of the battery refrigeration loop after heating the refrigerant, condensing the refrigerant of the battery refrigeration loop after compressing the refrigerant, and expanding the refrigerant of the battery refrigeration loop after condensing the refrigerant using the first electronic expansion valve. The method may further comprise measuring a second refrigerant temperature located at an outlet of a second chiller, measuring a second refrigerant pressure located at the outlet of the second chiller, and controlling a position of a second electronic expansion valve based upon a minimum value of the first and second refrigerant temperatures and a maximum value of the first and second refrigerant pressures. The method may further comprise measuring a first battery temperature of the battery, and calculating a coolant flow rate using the first battery temperature. The method may further comprise measuring a first battery coolant temperature located at a battery inlet, and calculating a compressor speed command based upon the coolant flow rate, the first battery coolant temperature, and a battery coolant temperature setpoint.

In various embodiments, the method further comprises measuring a first battery temperature of the battery, measuring a second battery temperature of a second battery thermally coupled in parallel with the battery, and calculating a coolant flow rate using a maximum of the first battery temperature and the second battery temperature. In various embodiments, the method further comprises passing the coolant through a first coolant line of the battery coolant loop and a second coolant line of the battery coolant loop, the first coolant line is coupled in parallel with the second coolant line, the battery is thermally coupled with the first coolant line and a second battery is thermally coupled with the second coolant line.

A method of managing thermal loads in an electric vehicle may comprise heating, utilizing waste heat from a battery, a battery coolant of a battery coolant loop to form a heated battery coolant, heating a refrigerant of a battery refrigeration loop by exchanging heat with the heated battery coolant, measuring a coolant temperature located at a battery inlet, calculating a difference between a coolant temperature setpoint and the coolant temperature, calculating a compressor speed command using the difference and a normalized coolant flow rate, and controlling a speed of a first compressor in the battery coolant loop based upon the compressor speed command.

In various embodiments, the method may further comprise calculating a condenser fan speed command using the compressor speed command, and controlling a speed of a condenser fan in the battery refrigeration loop based upon the condenser fan speed command. Calculating the compressor speed command using the difference and the normalized coolant flow rate may comprise multiplying the difference and the normalized coolant flow rate to obtain an error value, and performing a proportional-integral-derivative (PID) control using the error value to compute an output variable. The compressor speed command may be calculated using at least one of a lookup table or a polynomial expression. The condenser fan speed command may be calculated using at least one of a lookup table or a polynomial expression. The compressor speed command may be calculated further based upon a coolant flow rate, the normalized coolant flow rate determined based upon the coolant flow rate.

In various embodiments, the method further comprises calculating the coolant flow rate using at least one of a first measured battery temperature or a second measured battery temperature.

A thermal management system for an electric vehicle may comprise a first battery, a battery coolant loop thermally coupled to the first battery and comprising a first chiller and a first pump, a battery refrigeration loop comprising the first chiller thermally coupled to a compressor and a first electronic expansion valve, and a controller in electronic communication with the first electronic expansion valve, the controller configured to control a position of the first electronic expansion valve. The first chiller may be configured to transfer waste heat from the first battery to a refrigerant of the battery refrigeration loop.

In various embodiments, the battery coolant loop may further comprise a first check valve, a first shut-off valve, and an expansion tank. The first battery, the first chiller, the first pump, the first check valve, the first shut-off valve, and the first expansion tank may be thermally and fluidly coupled via a battery coolant line. The thermal management system may further comprise a first refrigerant pressure sensor configured to measure a first refrigerant pressure at an outlet of the first chiller, a first refrigerant temperature sensor configured to measure a first refrigerant temperature at the outlet of the first chiller, a first coolant temperature sensor configured to measure a first coolant temperature at an inlet of the first battery, a second coolant temperature sensor configured to measure a second coolant temperature at an outlet of the first battery, and a first battery temperature sensor configured to measure a first battery surface temperature. The controller may be configured to control the position of the first electronic expansion valve based upon the first refrigerant temperature and the first refrigerant pressure. The battery coolant loop may further comprise a second battery, a second pump, a second check valve, a second shut-off valve, and a second chiller. The first battery, the first pump, the first check valve, the first shut-off valve may be coupled in parallel with the second battery, the second pump, the second check valve, and the second shut-off valve. The first chiller may be coupled in parallel with the second chiller. The thermal management system may further comprise a second refrigerant pressure sensor configured to measure a second refrigerant pressure at an outlet of the second chiller, a second refrigerant temperature sensor configured to measure a second refrigerant temperature at the outlet of the second chiller, a third coolant temperature sensor configured to measure a third coolant temperature at an outlet of the second battery, and a second battery temperature sensor configured to measure a second battery surface temperature. The controller may be configured to control the position of the first electronic expansion valve based upon a minimum of the first refrigerant temperature and the second refrigerant temperature and a maximum of the first refrigerant pressure and the second refrigerant pressure. The battery refrigeration loop may further comprise a condenser and a second electronic expansion valve. The controller may utilize a proportional-integral-derivative control for calculating an electronic expansion valve position command for controlling the position of the first electronic expansion valve.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a perspective view of an electric vehicle containing a vehicle battery thermal management system, in accordance with various embodiments;

FIG. 2 illustrates a vehicle battery thermal management system, in accordance with various embodiments;

FIG. 3 illustrates a flow chart of a method for managing battery thermal loads in an electric vehicle, and more particularly for battery coolant pump speed control, in accordance with various embodiments;

FIG. 4 illustrates a block diagram of a control logic for implementing the method of FIG. 3, in accordance with various embodiments;

FIG. 5 illustrates a flow chart of a method for managing battery thermal loads in an electric vehicle, and more particularly for battery refrigerant compressor speed control and condenser fan speed control, in accordance with various embodiments;

FIG. 6 illustrates a block diagram of a control logic for implementing the method of FIG. in accordance with various embodiments;

FIG. 7 illustrates a flow chart of a method for managing battery thermal loads in an electric vehicle, and more particularly for electronic expansion valve position control, in accordance with various embodiments;

FIG. 8 illustrates a block diagram of a control logic for implementing the method of FIG. 7, in accordance with various embodiments;

FIG. 9 illustrates a vehicle battery thermal management system, in accordance with various embodiments;

FIG. 10 illustrates a flow chart of a method for managing battery thermal loads in an electric vehicle, and more particularly for battery coolant pump speed control, in accordance with various embodiments;

FIG. 11 illustrates a block diagram of a control logic for implementing the method of FIG. 10, in accordance with various embodiments;

FIG. 12 illustrates a flow chart of a method of managing thermal loads in an electric vehicle, in accordance with various embodiments;

FIG. 13 illustrates a block diagram of a control logic for a thermal management system, in accordance with various embodiments;

FIG. 14 illustrates a flow chart of a method for managing battery thermal loads in an electric vehicle, and more particularly for battery refrigerant compressor speed, in accordance with various embodiments;

FIG. 15 illustrates a block diagram of a control logic for implementing the method of FIG. 14, in accordance with various embodiments;

FIG. 16 illustrates a flow chart of a method for managing battery thermal loads in an electric vehicle, and more particularly for condenser fan speed control, in accordance with various embodiments;

FIG. 17 illustrates a block diagram of a control logic for implementing the method of FIG. 16, in accordance with various embodiments;

FIG. 18 illustrates a flow chart of a method for managing battery thermal loads in an electric vehicle, and more particularly for electronic expansion valve position control, in accordance with various embodiments;

FIG. 19 illustrates a block diagram of a control logic for implementing the method of FIG. 18, in accordance with various embodiments;

FIG. 20 illustrates a flow chart of a method for managing thermal loads in an electric vehicle, and more particularly for battery heater control, in accordance with various embodiments;

FIG. 21 illustrates a block diagram of a control logic for implementing the method of FIG. 20, in accordance with various embodiments;

FIG. 22 illustrates a flow chart of a method for managing battery thermal loads in an electric vehicle, and more particularly for chiller mode switching control, in accordance with various embodiments;

FIG. 23 illustrates a flow chart of a method for managing battery thermal loads in an electric vehicle, and more particularly for heater mode switching control, in accordance with various embodiments;

FIG. 24 illustrates a flow chart of a method for managing battery thermal loads in an electric vehicle, and more particularly for chiller-heater mode switching control, in accordance with various embodiments; and

FIG. 25 illustrates a block diagram of a control logic for implementing the methods of FIGS. 22-24, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

For example, in the context of the present disclosure, methods, systems, and articles may find particular use in connection with electric vehicles, fuel cell electric vehicles, battery electric vehicles, compressed natural gas (CNG) vehicles, hythane (mix of hydrogen and natural gas) vehicles, and/or the like. However, various aspects of the disclosed embodiments may be adapted for performance in a variety of other systems. Further, in the context of the present disclosure, methods, systems, and articles may find particular use in any system requiring use of a battery, fuel cell, and/or thermal management system of the same. As such, numerous applications of the present disclosure may be realized.

The following nomenclature in Table 1, Table 2, and Table 3 corresponds to measured parameters, controlled parameters, and selected parameters, respectively, described in the present disclosure:

TABLE 1
Sensor Measurements

| Measurement | |
|---|---|
| Sensor | Description |
| T_{amb} | Ambient temperature (° C.) |
| T_{bat,1} | Battery 1 temperature (° C.) |
| T_{bat,2} | Battery 2 temperature (° C.) |
| T_{bat,3} | Battery 3 temperature (° C.) |
| T_{b}_in | Coolant temperature at battery system inlet (° C.) |
| T_{b}_out,1 | Coolant temperature at battery 1 outlet (° C.) |
| T_{b}_out,2 | Coolant temperature at battery 2 outlet (° C.) |
| T_{b}_out,3 | Coolant temperature at battery 3 outlet (° C.) |
| T_{comp} | Refrigerant temperature at outlet of compressor (° C.) |
| T_{cond} | Refrigerant temperature at outlet of condenser (° C.) |
| T_{chill,1} | Refrigerant temperature at outlet of chiller 1 (° C.) |
| T_{chill,2} | Refrigerant temperature at outlet of chiller 2 (° C.) |
| P_{comp} | Refrigerant pressure at outlet of compressor (° C.) |
| P_{cond} | Refrigerant pressure at outlet of condenser (° C.) |
| P_{chill,1} | Refrigerant pressure at outlet of chiller 1 (° C.) |
| P_{chill,2} | Refrigerant pressure at outlet of chiller 2 (° C.) |
| Power_{bat,1} | Battery 1 power output (kW) |
| Power_{bat,2} | Battery 2 power output (kW) |
| SOC_{bat,1} | Battery 1 state of charge (%) |
| SOC_{bat,2} | Battery 2 state of charge (%) |

TABLE 2
Controlled Parameters

| Controlled | |
|---|---|
| Parameter | Description |
| N_{comp} | Battery loop compressor speed (RPM) |
| N_{fan} | Condenser fan speed (RPM) |
| Nₚᵤₘₚ | Battery loop pump speed (RPM) |
| V_{pos,EXV1} | EXV1 position (%) |
| V_{pos,EXV2} | EXV2 position (%) |
| Tₕₑₐₜₑᵣ | Battery heater temperature setpoint (° C.) |

TABLE 3
Selected/Calculated Parameters

| Selected/ | |
|---|---|
| Calculated | |
| Parameter | Description |
| V_{coolant} | Desired coolant flow (LPM) |
| Tₛₑₜₚₒᵢₙₜ | Coolant temperature setpoint (° C.) |
| dT_{sh,setpoint} | Chiller superheat setpoint (° C.) |
| P_{chill,setpoint} | Chiller outlet pressure setpoint (kPa) |
| P_{cond,setpoint} | Condenser outlet pressure setpoint (kPa) |
| dTₛₑₜₚₒᵢₙₜ | Coolant temperature difference setpoint (° C.) |
| dT_{sc,setpoint} | Condenser outlet subcooling setpoint (° C.) |
| Tₛₑₜₚₒᵢₙₜ_1 | Battery maximum temperature setpoint (° C.) |
| Tₛₑₜₚₒᵢₙₜ_2 | Battery minimum temperature setpoint (° C.) |
| Q_{battery} | Battery heat generation (kW) |
| T₁ | First reference temperature (° C.) |
| T₂ | Second reference temperature (° C.) |
| T₃ | Third reference temperature (° C.) |
| T₄ | Fourth reference temperature (° C.) |
| T₅ | Fifth reference temperature (° C.) |
| T₆ | Sixth reference temperature (° C.) |

Modern electric vehicles may utilize various power sources to provide electric current to one or more electric motors configured to drive the vehicle's wheels. Among the types of electric vehicles currently being researched and developed at a wide scale are FCEVs and BEVs. Similar to traditional internal combustion engine vehicles (ICEVs), electric vehicles may generate large amounts of waste heat through the operation of various system components. For example, battery systems may generate waste heat as a result of enthalpy changes, electrochemical polarization, and resistive heating inside of battery cells. Fuel cells may generate heat as a result of exothermic chemical reactions taking place in fuel cell catalyst layers. In the case of batteries, this additional heat can adversely impact the operation of the battery and reduce the life of the battery. While many types of fuel cells can efficiently operate at much higher temperature ranges than can batteries, the heat generated by the operation of the fuel cell may still impact other system components near the fuel cell. Accordingly, modern electric vehicles are typically equipped with one or more thermal management systems capable of managing the operating temperatures of various system components. By increasing the thermal efficiency of the thermal management system, certain components of the thermal management system may require less power from onboard batteries. As a result, battery capacity may be preserved and instead be utilized for other desirable purposes, for example to increase vehicle range.

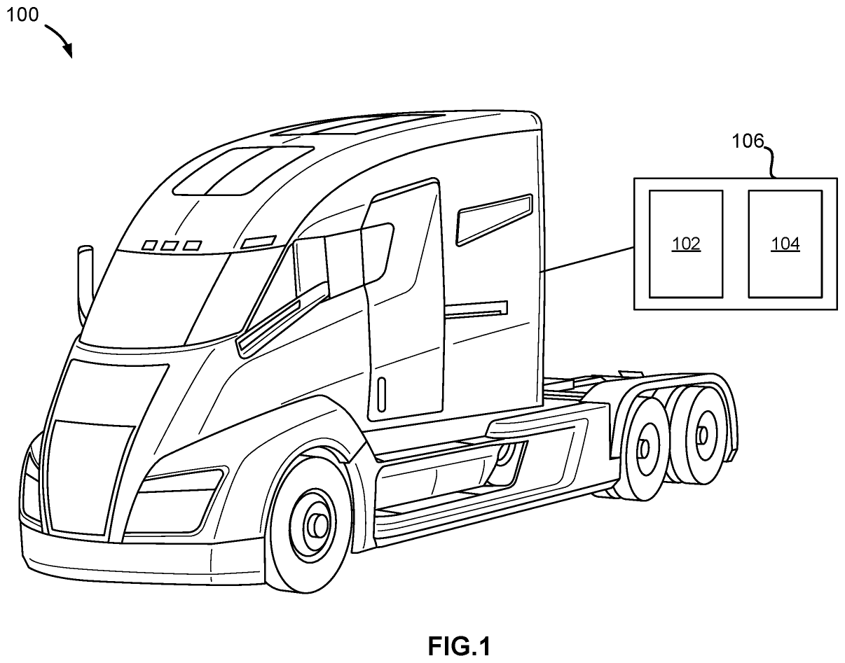

Accordingly, with reference to FIG. 1, a perspective view of a vehicle 100 incorporating a thermal management system is illustrated, in accordance with various embodiments. Vehicle 100 is an FCEV incorporating an electric powertrain. More specifically, vehicle 100 is an electric commercial vehicle, such as, for example, a class 8 heavy duty commercial vehicle. While described herein as an FCEV, vehicle 100 is not limited in this regard and may comprise any type, size, or function of vehicle. For example, vehicle 100 may comprise a BEV, CNG vehicle, hythane vehicle, or any other suitable vehicle. Moreover, vehicle 100 may comprise a commercial vehicle of a different weight class or a passenger vehicle in various embodiments. It should be appreciated that vehicle 100 may comprise any vehicle type that can utilize a thermal management system wherein waste heat from certain system components may be at least partially salvaged and dissipated through a vapor-compression refrigeration loop as discussed in further detail below.

With continued reference to FIG. 1, vehicle 100 may comprise a fuel cell stack 102 and a battery 104, which may be thermally regulated by a thermal management system 106. Fuel cell stack 102 and/or battery 104 may be configured to power one or more electric motors to drive vehicle 100. For example, fuel cell stack 102 and/or battery 104 may operate alone, in an alternating fashion, and/or in an alternating or staggered fashion to provide current to the one or more electric motors depending on operational objectives or conditions. As a result, fuel cell stack 102 and battery 104 may undergo times of relatively low energy output (corresponding to relatively low heat output) and times of relatively high energy output (corresponding to relatively high heat output). Additionally, battery 104 may undergo periods of elevated heat output responsive to charging of battery 104. In various embodiments, thermal management system 106 includes one or more controllers (e.g., processors) and one or more tangible, non-transitory memories capable of implementing digital or programmatic logic. In various embodiments, for example, the one or more controllers are one or more of a general-purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, as will be discussed in further detail below, thermal management system 106 is configured to monitor and/or manage temperatures of fuel cell stack 102, battery 104, control electronics of the same, and/or other system components. For example, thermal management system 106, which can be in thermal communication with fuel cell stack 102, battery 104, and other system components, may comprise multiple coolant and/or refrigeration loops configured to transfer thermal energy from areas of higher temperature to areas of lower temperature. While described as having both fuel cell stack 102 and battery 104, vehicle 100 is not limited in this regard and in various embodiments may comprise only battery 104, for example when vehicle 100 is a BEV.

In various embodiments, fuel cell stack 102 may comprise one or more fuel cells capable of facilitating an electrochemical reaction to produce an electric current. For example, the one or more fuel cells may be proton-exchange membrane (PEM) fuel cells which may receive a fuel source (such as diatomic hydrogen gas) which may react with an oxidizing agent (such as oxygen) to generate electricity with heat and water as byproducts. The fuel cells may be electrically coupled in series and/or parallel to increase voltage and/or current and form fuel cell stack 102. In various embodiments, fuel cell stack 102 may comprise fuel cells other than PEM fuel cells, for example, alkaline fuel cells, phosphoric acid fuel cells, molten carbonate fuel cells, solid oxide fuel cells, or any other suitable fuel cell type.

Battery 104 may be a rechargeable, or secondary, battery configured to store energy from an external power source (for example, a charging station), from fuel cell stack 102, from a solar panel disposed on vehicle 100, and/or from regenerative braking or other applications. Battery 104 may release this stored energy in the form of electricity to power one or more electric motors and/or to supply power to other vehicle components utilizing electricity to operate. In various embodiments, battery 104 may be a lithium-ion battery; however, battery 104 is not limited in this regard and may comprise other rechargeable battery types such as a lead-acid battery, nickel-cadmium battery, nickel-metal hydride battery, lithium iron sulfate battery, lithium iron phosphate battery, lithium sulfur battery, solid state battery, flow battery, or any other type of suitable battery. Battery 104 may further comprise multiple battery cells coupled in series and/or parallel to increase voltage and/or current. The cells of battery 104 may comprise any suitable structure including cylindrical cells, prismatic cells, or pouch cells. Moreover, battery 104 may at least partially comprise other energy storage technologies such as an ultracapacitor. As will be discussed further below, battery 104 may be in thermal communication with a battery coolant loop and a battery refrigeration loop configured to manage heat released from battery 104.

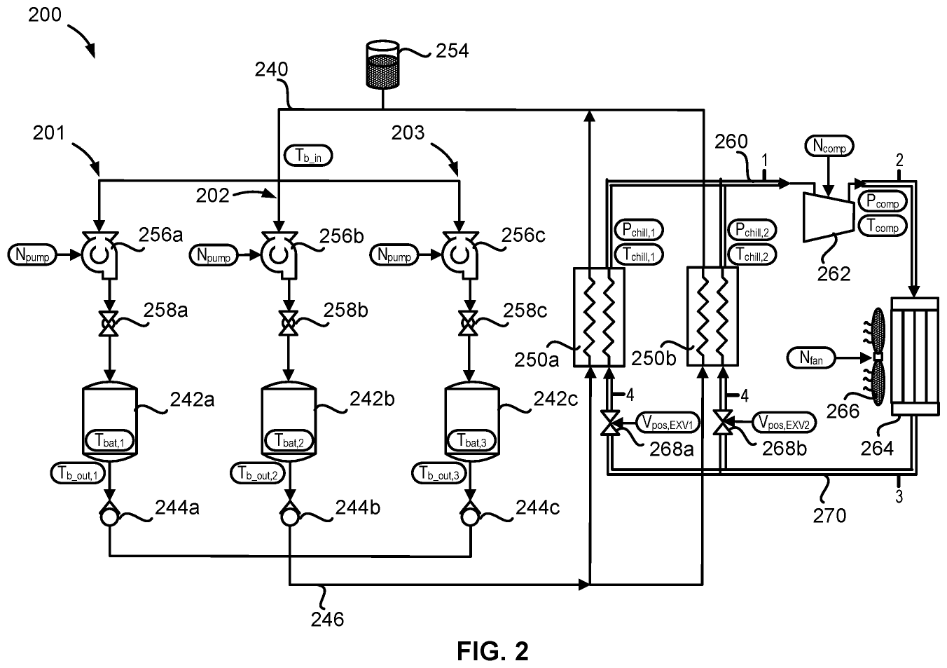

With reference now to FIG. 2, a vehicle battery thermal management system 200, which may be similar to thermal management system 106 of FIG. 1, is illustrated in accordance with various embodiments. Battery thermal management system 200 comprises a battery coolant loop 240 and a battery refrigeration loop 260. Battery coolant loop 240 may be configured to remove waste heat from one or more batteries (e.g., battery 242a, battery 242b, and/or battery 242c; referred to herein generally as battery 242) to ensure battery 242 operates within a desired temperature range, for example for efficiency, safety, longevity, reliability, or other desirable purposes. In various embodiments battery 242a, battery 242b, and/or battery 242c may comprise multiple (for example, two, three, or more) battery packs electrically coupled together in series or parallel. In the event battery coolant loop 240 is unable to maintain the temperature (for example, by dissipating heat through one or more radiators (not shown) thermally coupled to battery coolant loop 240) of battery 242 in a desired temperature range (for example, between about 25 degrees and about 30 degrees Celsius), battery refrigeration loop 260 may provide additional cooling to battery 242 utilizing a vapor-compression refrigeration cycle or other suitable refrigeration cycle.

Battery coolant loop 240 may comprise one or more chillers (e.g., chiller 250a and chiller 250b; referred to herein generally as chiller 250), an expansion tank 254, and a plurality of parallel coolant lines (e.g., first parallel line 201, second parallel line 202, and third parallel line 203), where each parallel coolant line comprises a pump (e.g., pump 256a, pump 256b, and pump 256c; referred to herein generally as pump 256), an electronic shut-off valve (e.g., shut-off valve 258a, shut-off valve 258b, and shut-off valve 258c; referred to herein generally as shut-off valve 258), battery 242 (e.g., battery 242a, battery 242b, and battery 242c), and a check valve (e.g., check valve 244a, check valve 244b, and check valve 244c; referred to herein generally as check valve 244) thermally coupled together in series by battery coolant line 246. For example, each of battery 242a, battery 242b, and battery 242c may comprise a dedicated check valve 244a, check valve 244b, and check valve 244c, respectively. While described herein as having three batteries 242 in parallel, the battery coolant loop 240 is not limited in this regard, and may comprise any desired number of batteries 242 thermally coupled in parallel. Battery coolant line 246 may thermally and fluidly couple all components of battery coolant loop 240 and may thermally and fluidly couple battery coolant loop 240 to battery 242. In various embodiments, battery 242 may be similar to battery 104 discussed with reference to FIG. 1. Battery coolant line 246 may contain a battery coolant that may comprise a liquid or gas that is configured to regulate the temperature of battery 242. In various embodiments, the battery coolant in battery coolant line 246 may have a high thermal capacity, a relatively low viscosity, and be chemically inert. The battery coolant may be a gaseous coolant such as air, helium or other inert gas, or liquid such as water, ethylene glycol, propylene glycol, betaine, polyalkylene glycol, or other suitable coolant.

Check valve 244 may comprise a two-way valve. In other words, check valve 244 may include two openings (e.g., one inlet and one outlet). Check valve 244 may prevent the battery coolant from reverse flow (i.e., prevents battery coolant from flowing from the chiller 250 to the battery 242, and further prevents battery coolant from flowing from one battery (e.g., battery 242a) to another battery (e.g., battery 242b and/or battery 242c)). Check valve 244 may be configured to receive the battery coolant through the inlet and direct the battery coolant to the outlet. For example, the battery coolant in battery coolant line 246 may absorb waste heat from battery 242 and be routed to check valve 244. Check valve 244 may direct the battery coolant to one or more chillers (e.g., chiller 250a and/or chiller 250b; referred to herein generally as chiller 250). As will be discussed in further detail below, chiller 250 may be configured to reduce thermal energy present in the battery coolant.

Chiller 250 may be fluidly and thermally coupled to expansion tank 254 via battery coolant line 246. Expansion tank 254 may be configured to protect battery coolant loop 240 by removing excess pressure resulting from heated battery coolant. For example, battery coolant traveling from chiller 250 or other system components may be at an elevated temperature despite heat exchange at chiller 250 or other system components. As the battery coolant expands with an increase in temperature, expansion tank 254 may be configured to accommodate the pressure increase to avoid exceeding a critical pressure limit of battery coolant loop 240 and/or prevent undesired venting of the battery coolant. In various embodiments, expansion tank 254 may comprise a compression expansion tank, bladder expansion tank, diaphragm expansion tank, or any other suitable expansion tank type. Expansion tank 254 may be fluidly and thermally coupled to one or more pump 256 (e.g., pump 256a, pump 256b, and/or pump 256c) via battery coolant line 246 wherein the pump 256 may be configured to circulate the battery coolant throughout battery coolant loop 240, including directly to battery 242. In various embodiments, each shut-off valve 258 is disposed inline between each pump 256 and its respective battery 242. In this regard, each pump 256 may be configured to circulate the battery coolant to battery 242 via its respective shut-off valve 258. However, each shut-off valve 258 may be fluidly coupled upstream from pump 256 or downstream from battery 242 in its respective parallel battery coolant line 246 for opening and/or closing the flow of battery coolant therethrough, as desired.

Under certain operating conditions, elevated ambient temperatures may decrease a temperature gradient between the heated battery coolant and the ambient environment, thereby decreasing the rate of convective heat transfer from the battery coolant to the ambient environment. To address such situations, battery coolant loop 240 may be equipped with chiller 250, which may be thermally coupled to battery refrigeration loop 260, to provide additional cooling for battery 242 in certain situations. Chiller 250 may serve as a heat exchanger (e.g., a refrigerant-to-coolant heat exchanger) where excess thermal energy in the battery coolant may be transferred to battery refrigeration loop 260, which may utilize a vapor-compression refrigeration cycle to absorb and dissipate the excess thermal energy. In various embodiments, chiller 250 may comprise an air chiller, water chiller, or other suitable heat exchange system.

As discussed above, battery thermal management system 200 may further comprise battery refrigeration loop 260. Battery refrigeration loop 260 may be thermally coupled to battery coolant loop 240 via chiller 250. In this regard, chiller 250 may be considered part of the battery refrigeration loop 260 in addition to, or alternative to, the battery coolant loop 240. Battery refrigeration loop 260 further comprises a compressor 262, a condenser 264 comprising a fan 266, and one or more expansion valves (e.g., expansion valve 268a and expansion valve 268b; referred to herein generally as expansion valve 268). Compressor 262, condenser 264, expansion valve 268, and chiller 250 may be thermally coupled via battery refrigerant line 270 to form battery refrigeration loop 260.

Battery refrigerant line 270 may contain a battery refrigerant configured to circulate throughout battery refrigeration loop 260 and undergo various phase, temperature, and/or pressure changes to absorb and dissipate thermal energy from various portions of battery thermal management system 200. In various embodiments, the battery refrigerant may comprise a fluid having a high latent heat of vaporization, moderate density in liquid form, high density in gaseous form, and high critical temperature. For example, the battery refrigerant may comprise a fluid containing various compounds such as fluorocarbons, ammonia, sulfur dioxide, or non-halogenated hydrocarbons among others. Further, the battery refrigerant may comprise a class 1, class 2, or class 3 refrigerant in various embodiments.

In various embodiments, the battery refrigerant may be configured to enter the compressor 262 in a gaseous state through battery refrigerant line 270 at point (1). In other words, the battery refrigerant may ideally comprise a vapor having a relatively low temperature and a relatively low pressure when entering compressor 262. Compressor 262 may compress the battery refrigerant thereby increasing the battery refrigerant pressure and temperature. Compressor 262 requires power to compress the battery refrigerant and may utilize an electric motor or other suitable power source. In various embodiments, compressor 262 may be a scroll, screw, centrifugal, reciprocating, or other suitable type of compressor. The battery refrigerant may exit compressor 262 as a superheated vapor at point (2).

The battery refrigerant, now in the form of a superheated vapor, may proceed through battery refrigerant line 270 to condenser 264. Condenser 264, which may be an air-cooled, evaporative, or water-cooled condenser, may contain one or more coils configured to contain the battery refrigerant entering condenser 264 through battery refrigerant line 270. Air, water, or other suitable cooling fluid may flow across the coils to extract thermal energy from battery refrigerant and eject the thermal energy as heat to the external environment. Fan 266 may serve to increase convective heat transfer from the battery refrigerant to the cooling fluid and/or assist in directing the cooling fluid out of condenser 264. In this manner, battery refrigerant may be condensed as it passes through condenser 264. The battery refrigerant may exit condenser 264 as a cooled, saturated liquid at point (3). The battery refrigerant may exit condenser 264 as a subcooled (i.e., cooled to below its saturation temperature) liquid at point (3).

The battery refrigerant, now in the form of a saturated liquid, may proceed through battery refrigerant line 270 to expansion valve 268. Expansion valve 268 may be configured to control the amount of battery refrigerant that enters chiller 250. Expansion valve 268 may be configured to ensure that the battery refrigerant exits chiller 250 as a superheated vapor. For example, expansion valve 268 may be an electronic expansion valve (EXV) which may be electrically controlled using a control algorithm to ensure the battery refrigerant exits chiller 250 at a desired temperature and pressure (and/or within desired temperature and pressure ranges, for example between about 10° C. and about 30° C., and between about 30 PSIG and 70 PSIG). For example, one or more pressure and/or temperature sensors may be positioned downstream of chiller 250 which may signal a desire for expansion valve 268 to increase or decrease a flow rate of battery refrigerant flowing through expansion valve 268. In various embodiments, expansion valve 268 may be an internally or externally equalized valve. Expansion valve 268 may be configured to abruptly decrease a pressure of the battery refrigerant. Such a decrease in pressure may result in flash evaporation of a portion of the liquid battery refrigerant and may lower the temperature of the battery refrigerant, now a liquid-vapor mixture at point (4). In this manner, the battery refrigerant may be expanded as it passes through expansion valve 268.

As discussed briefly above, the battery refrigerant may be configured to cool battery 242 by exchanging heat between the cooled battery refrigerant exiting expansion valve 268 and heated battery coolant exiting check valve 244. For example, in various embodiments, chiller 250 may comprise a concurrent or countercurrent heat exchanger comprising a series of conduits for the battery refrigerant and battery coolant. As the battery refrigerant and battery coolant flow through chiller 250, thermal energy may be transferred from the battery coolant to the battery refrigerant. As a result, cooling may be provided to battery 242.

To provide the desirable cooling capacity for the batteries, the electronic components (e.g., pump 256, compressor 262, fan 266, expansion valve 268, shut-off valve 258, and/or battery 242) are regulated using a feedback control method. In various exemplary embodiments, the method involves utilizing various feedback sensors, including coolant temperature sensors at the battery system inlet (see T_{b_in}) and at the battery outlet of each battery (see T_{b_out}), as well as battery surface temperature sensors (see T_{bat}). The control method may further utilize refrigerant pressure and temperature sensors located at the compressor outlet (see P_{comp} and T_{comp}) and at the outlet of each chiller (see P_{chill} and T_{chill}).

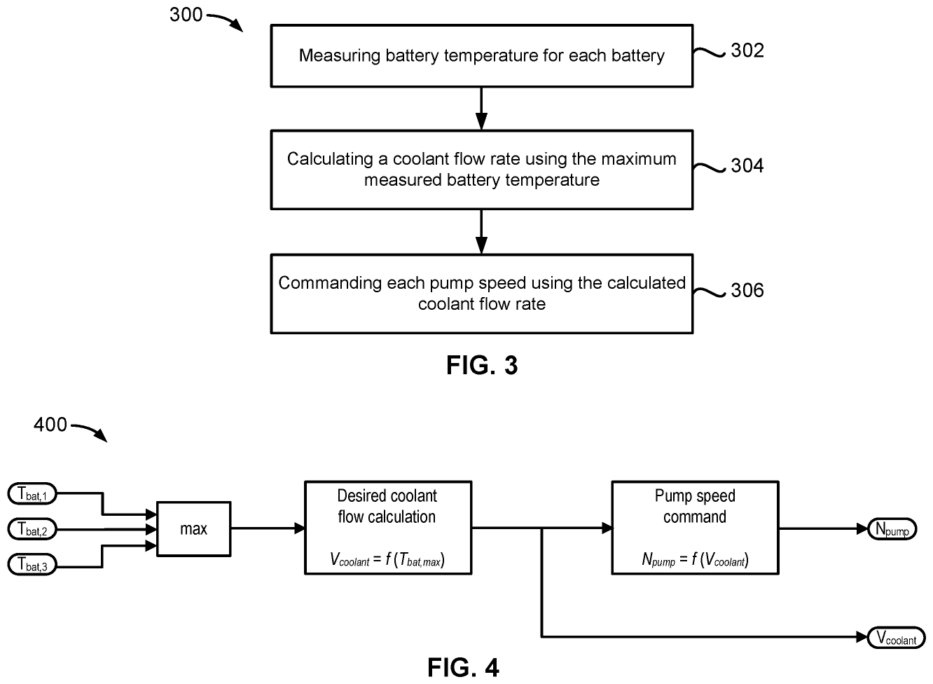

With reference now to FIG. 3, a flow chart illustrating a method 300 of managing thermal loads in an electric vehicle (e.g., a BEV and/or an FCEV) is illustrated in accordance with various embodiments. Method 300 may comprise measuring a battery temperature for each battery (step 302). Method 300 may further comprise calculating a coolant flow rate using the maximum measured battery temperature (step 304). Method 300 may further comprise commanding each pump speed using the calculated coolant flow rate (step 306). In various embodiments, method 300 further comprises heating a battery coolant of a battery coolant loop utilizing waste heat from a battery to form a heated battery coolant. In various embodiments, method 300 further comprises heating a refrigerant of a battery refrigeration loop by exchanging heat with the heated battery coolant.

With reference now to FIG. 4, a block diagram of a control logic 400 for a thermal management system (e.g., thermal management system 106) is illustrated, in accordance with various embodiments. Control logic 400 may implement a method (e.g., method 300 of FIG. 3) for managing thermal loads in an electric vehicle (e.g., a BEV and/or an FCEV). More particularly, control logic 400 may be used for calculating a desired battery coolant flow and commanding a pump speed accordingly. With combined reference to FIG. 1, FIG. 2, and FIG. 4, control logic 400 may be implemented by thermal management system 106. Control logic 400 may receive a plurality of measured battery temperatures (e.g., T_{bat,1}, T_{bat,2}, T_{bat,3}). These measured battery temperatures may be surface temperatures for each battery 242 (for example, the temperature associated with an inner or outer surface of the battery enclosure). In some exemplary embodiments, the measured battery temperatures may be internal temperatures for each battery 242 (for example, the temperature associated with a given battery cell, group of battery cells, battery module, or group of battery modules). Control logic 400 may be configured to select the maximum measured battery temperature for use in calculating a desired coolant flow rate (e.g., V_{coolant}). Based on the maximum of these battery temperature measurements, the desired coolant flow rate (V_{coolant}) may be calculated using a lookup table or a polynomial expression, for example. For example, the desired coolant flow rate may increase with the maximum measured battery temperature. The desired coolant flow rate (V_{coolant}) may then be used to determine the pump speed command (Nₚᵤₘₚ) using calibrated and/or empirical data. Each pump 256 may be commanded (e.g., by thermal management system 106) to the same speed to avoid uneven flow through the battery packs 242, which could lead to uneven surface temperatures.

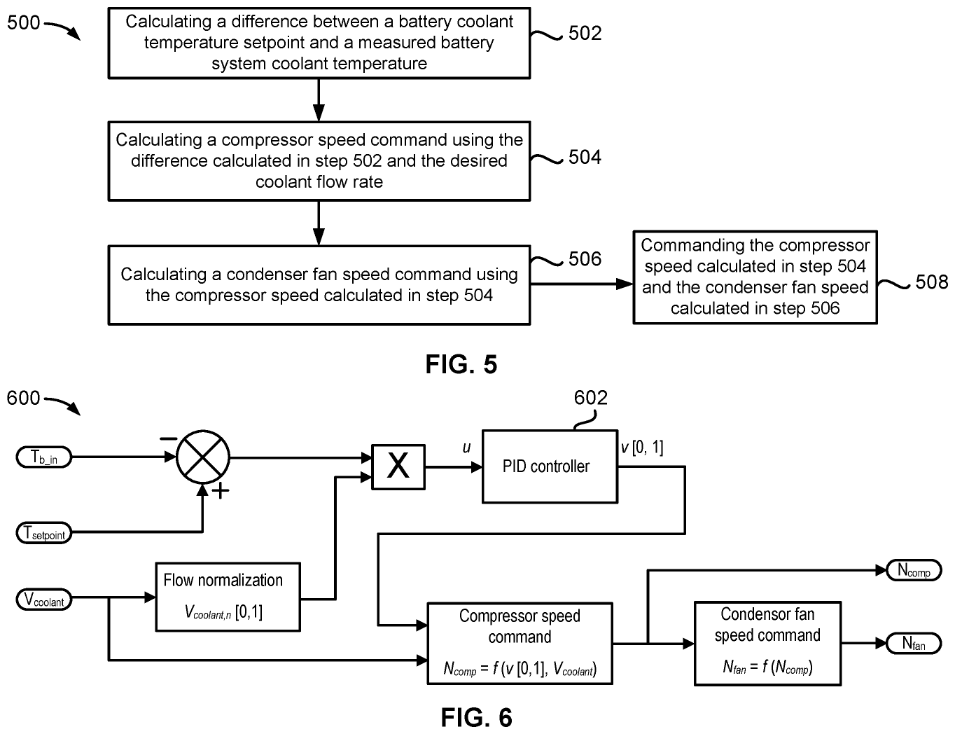

With reference now to FIG. 5, a flow chart illustrating a method 500 of managing thermal loads in an electric vehicle (e.g., a BEV and/or an FCEV) is illustrated in accordance with various embodiments. In various embodiments, method 500 is performed subsequent to and/or concurrently with method 300 described with respect to FIG. 3 and FIG. 4 as the output from control logic 400 is an input to control logic 600. Method 500 may comprise calculating a difference between a battery coolant temperature setpoint and a measured battery system coolant temperature (step 502). Method 500 may further comprise calculating a compressor speed command using the calculated difference and the desired coolant flow rate (step 504). Method 500 may further comprise calculating condenser fan speed using the compressor speed calculated in step 504 (step 506). Method 500 may further comprise commanding a compressor to operate at the compressor speed calculated in step 504 (step 508). Method 500 may further comprise commanding a condenser fan to operate at the condenser fan speed calculated in step 506 (step 508). In various embodiments, method 500 further comprises heating a battery coolant of a battery coolant loop utilizing waste heat from a battery to form a heated battery coolant. In various embodiments, method 500 further comprises heating a refrigerant of a battery refrigeration loop by exchanging heat with the heated battery coolant.

With reference now to FIG. 6, a block diagram of a control logic 600 for a thermal management system (e.g., thermal management system 106) is illustrated, in accordance with various embodiments. Control logic 600 may implement a method (e.g., method 500 of FIG. 5) for managing thermal loads in an electric vehicle (e.g., a BEV and/or an FCEV). More particularly, control logic 600 may be used for calculating a compressor speed command and a condenser fan speed command accordingly. With combined reference to FIG. 1, FIG. 2, and FIG. 6, control logic 600 may be implemented by thermal management system 106. Control logic 600 may regulate compressor speed using a PID (proportional-integral-derivative) controller based on feedback of the coolant temperature measured at the inlet of the battery system as well as the desired coolant flow rate (V_{coolant}) derived as described with respect to FIG. 3 and FIG. 4. Control logic 600 may receive the desired coolant flow rate (V_{coolant}) described with respect to FIG. 3 and FIG. 4. Control logic 600 may further receive, and calculate a difference between, a battery coolant temperature setpoint (Tₛₑₜₚₒᵢₙₜ) and a measured battery system inlet coolant temperature (T_{b_in}). The battery coolant temperature setpoint (Tₛₑₜₚₒᵢₙₜ) may be any suitable temperature (e.g., 25° C.) as desired, and may be a desired temperature of the battery coolant at the inlet (upstream) to the battery system (for example, battery 242a, battery 242b, battery 242c). The desired coolant flow rate (V_{coolant}) may be normalized such that it varies between 0 and 1. In this manner, desired coolant flow rate (V_{coolant}) may act as a PID controller gain. The difference between the battery coolant temperature setpoint/reference (Tₛₑₜₚₒᵢₙₜ) and the measured battery system inlet coolant temperature (T_{b_in}) may be multiplied by the normalized coolant flow rate (V_{coolant}) to obtain the error value (u) for the PID controller 602. This error value (u) may be minimized by the PID controller 602 by adjusting and optimizing the PID output variable (v) using proportional, integral, and/or derivative control actions. The output variable (v) may be a value between 0 and 1. The output variable (v) and the desired coolant flow rate (V_{coolant}) are then used to compute the compressor speed command (N_{comp}), for example using a lookup table or an empirical correlation. In addition, the condenser fan speed (N_{fan}) may be calculated from the set compressor speed (N_{comp}), for example using a lookup table or polynomial expression. The thermal management system 106 may command the compressor 262 to operate at the compressor speed (N_{comp}) calculated using control logic 600. The thermal management system 106 may command the fan 266 to operate at the condenser fan speed (N_{fan}) calculated using control logic 600.

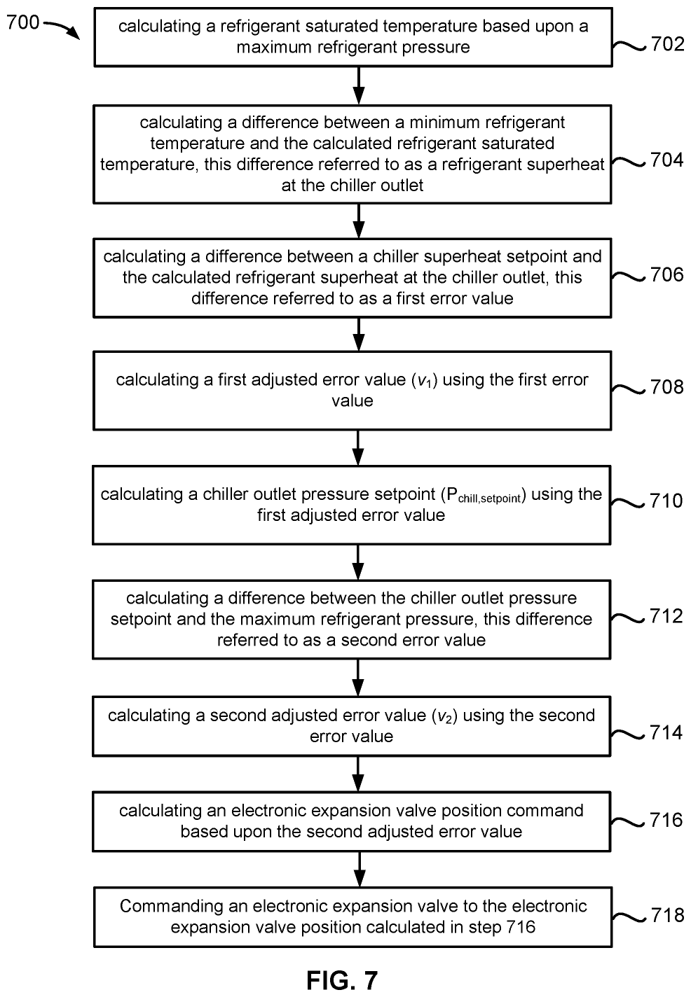

With reference now to FIG. 7, a flow chart illustrating a method 700 of managing thermal loads in an electric vehicle (e.g., a BEV and/or an FCEV) is illustrated in accordance with various embodiments. Method 700 may comprise calculating a refrigerant saturated temperature based upon a maximum refrigerant pressure (step 702). Method 700 may further comprise calculating a difference between a minimum refrigerant temperature and the calculated refrigerant saturated temperature, this difference referred to as a refrigerant superheat at the chiller outlet (step 704). Method 700 may further comprise calculating a difference between a chiller superheat setpoint and the calculated refrigerant superheat at the chiller outlet, this difference referred to as a first error value (step 706). Method 700 may further comprise calculating a first output variable (v₁) using the first error value (step 708). Method 700 may further comprise calculating a chiller outlet pressure setpoint (P_{chill,setpoint}) using the first output variable (step 710). Method 700 may further comprise calculating a difference between the chiller outlet pressure setpoint and the maximum refrigerant pressure, this difference referred to as a second error value (step 712). Method 700 may further comprise calculating a second output variable (v₂) using the second error value (step 714). Method 700 may further comprise calculating an electronic expansion valve position command based upon the second output variable (step 716). Method 700 may further comprise commanding an electronic expansion valve to the electronic expansion valve position calculated in step 716 (step 718). In various embodiments, method 700 further comprises heating a battery coolant of a battery coolant loop utilizing waste heat from a battery to form a heated battery coolant. In various embodiments, method 700 further comprises heating a refrigerant of a battery refrigeration loop by exchanging heat with the heated battery coolant.

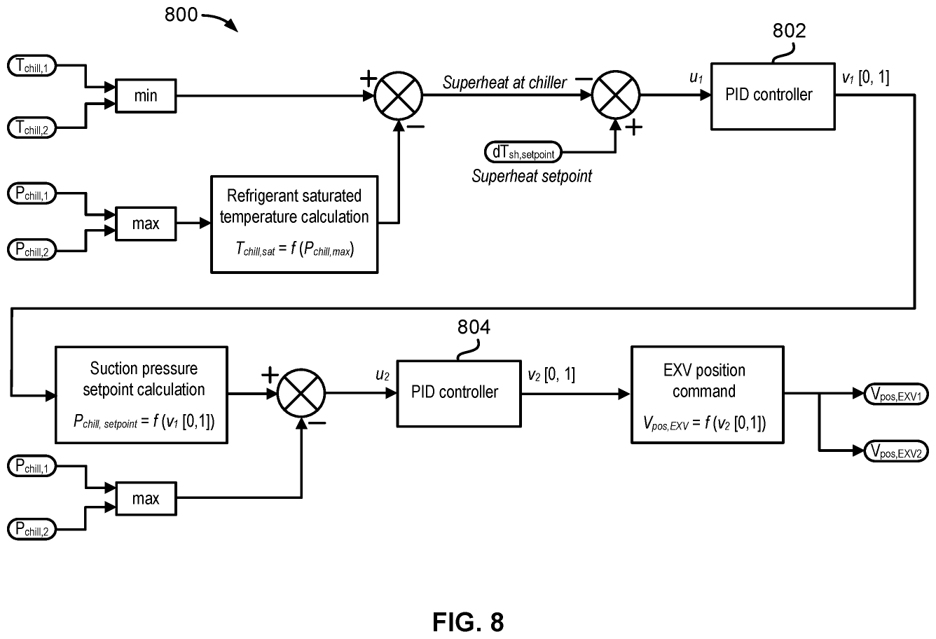

With reference now to FIG. 8, a block diagram of a control logic 800 for a thermal management system (e.g., thermal management system 106) is illustrated, in accordance with various embodiments. Control logic 800 may implement a method (e.g., method 700 of FIG. 7) for managing thermal loads in an electric vehicle (e.g., a BEV and/or an FCEV). More particularly, control logic 800 may be used for calculating one or more electronic expansion valve position commands accordingly. With combined reference to FIG. 1, FIG. 2, and FIG. 8, control logic 800 may be implemented by thermal management system 106. The electronic expansion valve positions may be regulated by control logic 800 using a cascade PID controller based on refrigerant pressure and temperature measurements at the outlet of each chiller 250. The cascade controller may utilize two PID blocks in this case where the output variable from the first block is used as the desired setpoint (or reference) for the second PID block. In this manner, the effect of fluctuations or disturbances in measurements are dampened at the final output variable (EXV position). This may ensure smooth performance of the refrigeration system.

Control logic 800 may receive a plurality of refrigerant temperatures (e.g., T_{chill,1} and T_{chill,2}), each measured at an outlet of the respective chiller 250. Control logic 800 may receive a plurality of refrigerant pressures (e.g., P_{chill,1} and P_{chill,2}), each measured at the outlet of the respective chiller 250. In this regard, step 702 of FIG. 7 may further include receiving, by control logic 800 and/or thermal management system 106, refrigerant temperatures (e.g., T_{chill,1} and T_{chill,2}) and refrigerant pressures (e.g., P_{chill,1} and P_{chill,2}) from temperature and pressure sensors, respectively, located at respective outlets of each chiller 250. Control logic 800 may calculate a refrigerant saturated temperature (T_{chill,sat}) based upon the maximum refrigerant pressure (e.g., the greater of T_{chill,1} and T_{chill,2}). The refrigerant saturated temperature (T_{chill,sat}) may be calculated using a lookup table or a polynomial expression. Control logic 800 may calculate a difference between a minimum refrigerant temperature (e.g., the lesser of T_{chill,1} and T_{chill,2}) and the calculated refrigerant saturated temperature, this difference referred to as a refrigerant superheat at the chiller outlet. Stated differently, the refrigerant superheat at the chiller outlet may be defined as the difference between the measured temperature of the superheated refrigerant vapor and the saturation temperature at the same point. Control logic 800 may calculate a difference between a chiller superheat setpoint (dT_{sh,setpoint}), for example 10° C., and the calculated refrigerant superheat at the chiller outlet, this difference referred to as a first error value (u₁). The difference (u₁) between the desired chiller superheat setpoint and the calculated superheat may be used as the error value for a first PID controller 802 (which may be the same controller as or a different controller from PID controller 602). This error value (u₁) is minimized by the first PID controller 802 (which may be the same controller as or a different controller from PID controller 602) by adjusting and optimizing the output variable (v₁). Stated differently, control logic 800 may calculate a first output variable (v₁) using the first error value (u₁). The output variable (v1) is then used to compute the chiller outlet (suction) pressure setpoint (P_{chill,setpoint}) via a lookup table or a polynomial expression. Stated differently, control logic 800 may calculate the chiller outlet pressure setpoint (P_{chill,setpoint}) using the first output variable value (v₁).

For the second PID controller 804 (which may be the same controller as or a different controller from PID controller 602, 802), the difference between the chiller outlet pressure setpoint (P_{chill,setpoint}) and the maximum of the two pressure measurements at the chiller outlets (e.g., the greater of P_{chill,1} and P_{chill,2}) is used as the second error value (u₂). Stated differently, control logic 800 may calculate a difference between the chiller outlet pressure setpoint (P_{chill,setpoint}) and the maximum refrigerant pressure (e.g., the greater of P_{chill,1} and P_{chill,2}), this difference referred to as the second error value (u₂). This second error value (u₂) is minimized by the second PID controller 804 by adjusting and optimizing a second output variable (v₂). Stated differently, control logic 800 may calculate, using second PID controller 804, the second output variable (v₂) using the second error value (u₂). The EXV position command (V_{pos,EXVx}) is finally calculated from the second output variable (v₂), for example using either a lookup table or a polynomial expression. Stated differently, control logic 800 may calculate an electronic expansion valve position command (V_{pos,EXVx}) based upon the second output variable (v₂). Each expansion valve 268 may be commanded to the same position to avoid uneven mass flow rate, pressure, and temperature at the outlet of each chiller 250. The thermal management system 106 may command the expansion valve 268 to operate at the electronic expansion valve position command (V_{pos,EXV1} and V_{pos,EXV2}) calculated using control logic 800.

In order to ensure that the battery refrigerant enters compressor 262 as a fully vaporized battery refrigerant, control logic 600 and/or control logic 800 may utilize chiller outlet pressure and temperature feedback to control the speed of compressor 262 and fan 266 and/or the position of expansion valve 268. As a result, liquid battery refrigerant may be vaporized prior to entering compressor 262. Because the battery refrigerant is completely vaporized, battery refrigerant line 270 may be devoid of an accumulator downstream of chiller 250, thereby decreasing system cost and complexity.

A vehicle battery thermal management system of the present disclosure may tend to reduce electronic expansion valve position fluctuations as a result of the compressor operation adjusting to the varying heat load caused by the variable coolant flow and battery cell temperatures. A vehicle battery thermal management system of the present disclosure tends to ensure smooth refrigeration performance by limiting over/underreactions of various component outputs (i.e., valve position, compressor speed, etc.) in response to measured parameters, thereby leading to a more efficient thermal management system which may utilize less power input than traditional systems. Various benefits of a vehicle battery thermal management system of the present disclosure may be accomplished by utilizing a battery compressor speed control methods/logic and/or electronic expansion valve position control methods/logic.

More particularly, the battery compressor speed control methods/logic of the present disclosure modulates the compressor speed based on the cooling capacity to reach the desired battery inlet coolant temperature setpoint, in accordance with various embodiments. In this manner, the battery compressor speed control methods/logic of the present disclosure may aid in preventing overcooling of the batteries when there is little heat load on the chillers due to low pump speed/flow rate and/or low battery cell/coolant temperature. Moreover, controlling the cooling capacity tends to reduce compressor and fan speed fluctuations caused by varying pump speeds and flow rates. This tends to ensure smooth operation of the battery refrigeration system.

Still further, the electronic expansion valve position control methods/logic of the present disclosure modulates the electronic expansion valve position to maintain a desired superheat to ensure consistent operation and cooling of the battery compressor, in accordance with various embodiments. In this manner, the cascaded methods/logic tends to reduce position fluctuations caused by external disturbances or noise in measurements; pressure can change quickly in a refrigeration system, it is important to not react to high frequency changes. Accordingly, the methods/logic of the present disclosure may compensate for uneven refrigerant flow.

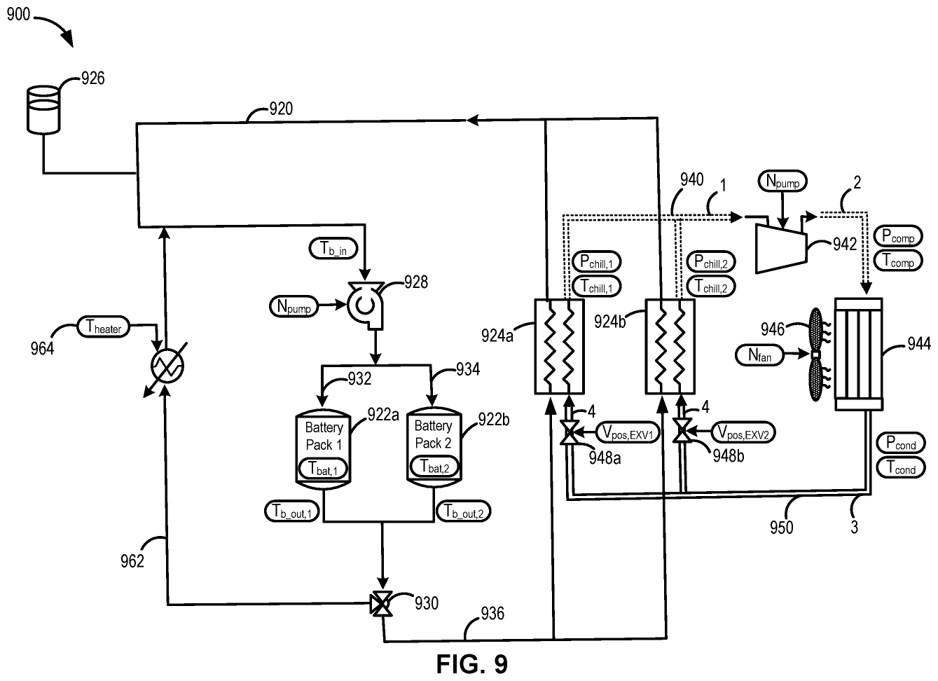

With reference now to FIG. 9, a vehicle battery thermal management system 900, which may be similar to thermal management system 106 of FIG. 1, is illustrated in accordance with various embodiments. Battery thermal management system 900 comprises a battery coolant loop 920 and a battery refrigeration loop 940. Thermal management system 900 may further comprise a battery heater loop 960 in various embodiments. Battery coolant loop 920 may be configured to remove waste heat from one or more batteries (e.g., battery 922a and/or battery 922b; referred to herein generally as battery 922) to ensure battery 922 operates within a desired temperature range, for example for efficiency, safety, longevity, reliability, or other desirable purposes. In addition, battery coolant loop 920 may be configured to provide heat to battery 922 to ensure battery 922 operates within a desired temperature range, for example, for efficiency, safety, longevity, reliability, or other desirable purposes. In various embodiments battery 922a and/or 922b may comprise multiple (for example, two, three, or more) battery packs electrically coupled together in series or parallel. In the event battery coolant loop 920 is unable to maintain the temperature (for example, by dissipating heat through one or more radiators (not shown) thermally coupled to battery coolant loop 920) of battery 922 in a desired temperature range (for example, between about 25 degrees and about 30 degrees Celsius), battery refrigeration loop 940 may provide additional cooling to battery 922 utilizing a vapor-compression refrigeration cycle or other suitable refrigeration cycle. Alternatively, battery heater loop 960 may provide heat to battery 922 to ensure battery 922 operates in the desired temperature range.

Battery coolant loop 920 may comprise one or more chillers (e.g., chiller 924a and chiller 924b; referred to herein generally as chiller 924), an expansion tank 926, a pump 928, a control valve 930, a plurality of parallel coolant lines (e.g., first parallel line 932 and second parallel line 934), where each parallel coolant line comprises battery 922 (e.g., battery 922a and battery 922b) thermally coupled together in series by battery coolant line 936. In various embodiments and similar to thermal management system 200, thermal management system 900 may comprise a plurality of pumps 928 with each pump thermally and fluidly coupled in series to a given battery 922 via the plurality of parallel coolant lines. As illustrated, pump 928 is positioned upstream of battery 922 and control valve 930 is positioned downstream of battery 922. However, in various embodiments, both pump 928 and control valve 930 may be positioned upstream of battery 922, downstream of battery 922, or control valve 930 upstream of battery 922 and pump 928 downstream of battery 922. While described herein as having two batteries 922 in parallel, battery coolant loop 920 is not limited in this regard, and may comprise any desired number of batteries 922 thermally coupled in parallel.

Battery coolant line 936 may thermally and fluidly couple all components of battery coolant loop 920 and may thermally and fluidly couple battery coolant loop 920 to battery 922. In various embodiments, battery coolant line 936 may comprise one or more branches to thermally and fluidly couple chiller 924a and 924b in parallel. Battery coolant line 936 may contain a battery coolant that may comprise a liquid or gas that is configured to regulate the temperature of battery 922. In various embodiments, the battery coolant in battery coolant line 936 may have a high thermal capacity, a relatively low viscosity, and be chemically inert. The battery coolant may be a gaseous coolant such as air, helium or other inert gas, or liquid such as water, ethylene glycol, propylene glycol, betaine, polyalkylene glycol, or other suitable coolant.

Control valve 930 may comprise a 3-way, 2-position valve in various embodiments. In other words, control valve 930 may include three openings (e.g., one inlet and two outlets). In various embodiments, control valve 930 may comprise a solenoid valve having an electric motor configured to switch a position of the valve depending on operating conditions and in response to signals received from vehicle control electronics as will be discussed in further detail below. Depending on operating mode and whether battery 922 requires cooling or heating, control valve 930 may be configured to receive battery coolant from battery 922 and direct the battery coolant to battery refrigeration loop 940 or to battery heater loop 960. For example, the battery coolant in battery coolant line 936 may absorb waste heat from battery 922 and be routed to chiller 924. Alternatively, the battery coolant in battery coolant line 936 may transfer heat to battery 922 after being heating in battery heater loop 960 and be recirculated through battery heater loop 960 to reheat the battery coolant.

In various embodiments, control valve 930 is thermally and fluidly coupled to a heater line 962 of battery heater loop 960. Heater line 962 may be configured to receive the battery coolant from control valve 930 and deliver the battery coolant to a battery heater 964 thermally and fluidly coupled to heater line 962. In various embodiments, battery heater 964 comprises a high voltage coolant heater comprising a heater track and one or more heating resistors configured to convert electrical energy to heat energy. Battery heater 964 may receive electric current from battery 922, for example, and transfer heat to the battery coolant as the battery current flows through battery heater 964. In various embodiments, heater line 962 may be thermally and fluidly coupled to battery coolant line 936 downstream of expansion tank 926 and upstream of pump 928 and may be configured to return heated battery coolant to battery coolant loop 920.

Chiller 924 may be fluidly and thermally coupled to expansion tank 926 via battery coolant line 936. Expansion tank 926 may be configured to protect battery coolant loop 920 by removing excess pressure resulting from heated battery coolant. For example, battery coolant traveling from chiller 924 or other system components may be at an elevated temperature despite heat exchange at chiller 924 or other system components. As the battery coolant expands with an increase in temperature, expansion tank 926 may be configured to accommodate the pressure increase to avoid exceeding a critical pressure limit of battery coolant loop 920 and/or prevent undesired venting of the battery coolant. In various embodiments, expansion tank 926 may comprise a compression expansion tank, bladder expansion tank, diaphragm expansion tank, or any other suitable expansion tank type. Expansion tank 926 may be fluidly and thermally coupled to pump 928 via battery coolant line 936 and pump 928 may be configured to circulate the battery coolant throughout battery coolant loop 920, including directly to battery 922.

Under certain operating conditions, elevated ambient temperatures may decrease a temperature gradient between the heated battery coolant and the ambient environment, thereby decreasing the rate of convective heat transfer from the battery coolant to the ambient environment. To address such situations, battery coolant loop 920 may be equipped with chiller 924, which may be thermally coupled to battery refrigeration loop 940, to provide additional cooling for battery 922 in certain situations. Chiller 924 may serve as a heat exchanger (e.g., a refrigerant-to-coolant heat exchanger) where excess thermal energy in the battery coolant may be transferred to battery refrigeration loop 940 which may utilize a vapor-compression refrigeration cycle to absorb and dissipate the excess thermal energy. In various embodiments, chiller 924 may comprise an air chiller, water chiller, or other suitable heat exchange system.

As discussed above, battery thermal management system 900 further comprises battery refrigeration loop 940. Battery refrigeration loop 940 may be thermally coupled to battery coolant loop 920 via chiller 924. In this regard, chiller 924 may be considered part of battery refrigeration loop 940 in addition to, or alternative to, the battery coolant loop 920. Battery refrigeration loop 940 further comprises a compressor 942, a condenser 944 comprising a fan 946, and one or more expansion valves (e.g., expansion valve 948a and expansion valve 948b; referred to herein generally as expansion valve 948). Compressor 942, condenser 944, expansion valve 948, and chiller 924 may be thermally coupled via battery refrigerant line 950 to form battery refrigeration loop 940.

Battery refrigerant line 950 may contain a battery refrigerant configured to circulate throughout battery refrigeration loop 940 and undergo various phase, temperature, and/or pressure changes to absorb and dissipate thermal energy from various portions of thermal management system 900. In various embodiments, the battery refrigerant may comprise a fluid having a high latent heat of vaporization, moderate density in liquid form, high density in gaseous form, and high critical temperature. For example, the battery refrigerant may comprise a fluid containing various compounds such as fluorocarbons, ammonia, sulfur dioxide, or non-halogenated hydrocarbons among others. Further, the battery refrigerant may comprise a class 1, class 2, or class 3 refrigerant in various embodiments.

In various embodiments, the battery refrigerant may be configured to enter compressor 942 in a gaseous state through battery refrigerant line 950 at point (1). In other words, the battery refrigerant may ideally comprise a vapor having a relatively low temperature and a relatively low pressure when entering compressor 942. Compressor 942 may compress the battery refrigerant thereby increasing the battery refrigerant pressure and temperature. Compressor 942 requires power to compress the battery refrigerant and may utilize an electric motor or other suitable power source. In various embodiments, compressor 942 may be a scroll, screw, centrifugal, reciprocating, or other suitable type of compressor. The battery refrigerant may exit compressor 942 as a superheated vapor at point (2).

The battery refrigerant, now in the form of a superheated vapor, may proceed through battery refrigerant line 950 to condenser 944. Condenser 944, which may be an air-cooled, evaporative, or water-cooled condenser, may contain one or more coils configured to contain the battery refrigerant entering condenser 944 through battery refrigerant line 950. Air, water, or other suitable cooling fluid may flow across the coils to extract thermal energy from battery refrigerant and eject the thermal energy as heat to the external environment. Fan 946 may serve to increase convective heat transfer from the battery refrigerant to the cooling fluid and/or assist in directing the cooling fluid out of condenser 944. In this manner, battery refrigerant may be condensed as it passes through condenser 944. The battery refrigerant may exit condenser 944 as a cooled, saturated liquid at point (3). The battery refrigerant may exit condenser 944 as a subcooled (i.e., cooled to below its saturation temperature) liquid at point (3).

The battery refrigerant, now in the form of a saturated liquid, may proceed through battery refrigerant line 950 to expansion valve 948. Expansion valve 948 may be configured to control the amount of battery refrigerant that enters chiller 924. Expansion valve 948 may be configured to ensure that the battery refrigerant exits chiller 924 as a superheated vapor. For example, expansion valve 948 may be an electronic expansion valve (EXV) which may be electrically controlled using a control algorithm to ensure the battery refrigerant exits chiller 924 at a desired temperature and pressure (and/or within desired temperature and pressure ranges, for example between about 10° C. and about 30° C., and between about 30 PSIG and 70 PSIG). For example, one or more pressure and/or temperature sensors may be positioned downstream of chiller 924 which may signal a desire for expansion valve 948 to increase or decrease a flow rate of battery refrigerant flowing through expansion valve 948. In various embodiments, expansion valve 948 may be an internally or externally equalized valve. Expansion valve 948 may be configured to abruptly decrease a pressure of the battery refrigerant. Such a decrease in pressure may result in flash evaporation of a portion of the liquid battery refrigerant and may lower the temperature of the battery refrigerant, now a liquid-vapor mixture at point (4). In this manner, the battery refrigerant may be expanded as it passes through expansion valve 948.

As discussed briefly above, the battery refrigerant may be configured to cool battery 922 by exchanging heat between the cooled battery refrigerant exiting expansion valve 948 and heated battery coolant exiting control valve 930. For example, in various embodiments, chiller 924 may comprise a concurrent or countercurrent heat exchanger comprising a series of conduits for the battery refrigerant and battery coolant. As the battery refrigerant and battery coolant flow through chiller 924, thermal energy may be transferred from the battery coolant to the battery refrigerant. As a result, depending on need, cooling may be provided to battery 922.

To provide the desirable thermal management of battery 922, the electronic components (e.g., pump 928, compressor 942, fan 946, expansion valve 948, control valve 930, battery heater 964, and/or battery 922) are regulated using a feedback control method. In various exemplary embodiments, the method involves utilizing various feedback sensors, including coolant temperature sensors at the battery system inlet (see T_{b_in}) and at the battery outlet of each battery (see T_{b_out}), as well as battery surface temperature sensors (see T_{bat}). The control method may further utilize refrigerant pressure and temperature sensors located at the compressor outlet (see P_{comp} and T_{comp}), the condenser outlet (see P_{cond} and T_{cond}), and at the outlet of each chiller (see P_{chill} and T_{chill}).

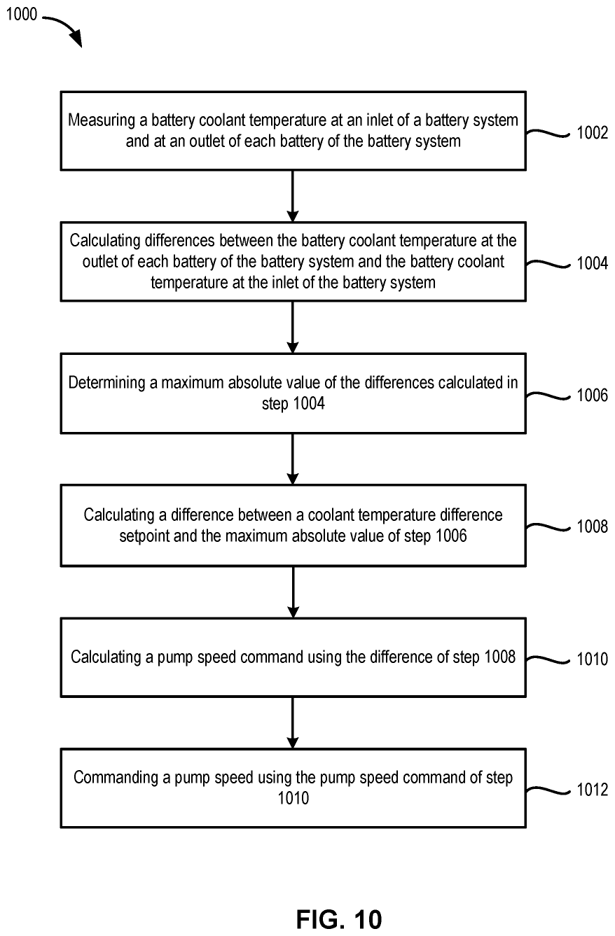

With reference now to FIG. 10, a flow chart illustrating a method 1000 of managing thermal loads in an electric vehicle (e.g., a BEV and/or an FCEV) is illustrated in accordance with various embodiments. Method 1000 may comprise measuring a battery coolant temperature at an inlet of a battery system and measuring a battery coolant temperature at an outlet of each battery of the battery system (step 1002). Method 1000 may further comprise calculating differences between the battery coolant temperature at the outlet of each battery of the battery system and the battery coolant temperature at the inlet of the battery system (step 1004). Method 1000 may further comprise determining a maximum absolute value of the calculated differences of step 1004 (step 1006). Method 1000 may further comprise calculating a difference between a coolant temperature difference setpoint and the maximum absolute value of step 1006 (step 1008). Method 1000 may further comprise calculating a pump speed command using the difference of step 1008 (step 1010). Method 1000 may further comprise commanding a pump speed using the pump speed command of step 1010 (step 1012). In various embodiments, method 1000 further comprises heating the battery coolant utilizing waste heat from the battery system to form a heated battery coolant and heating a refrigerant of a battery refrigeration loop by exchanging heat with the heated battery coolant. In various embodiments, method 1000 further comprises heating the battery coolant using heat from a battery heater.

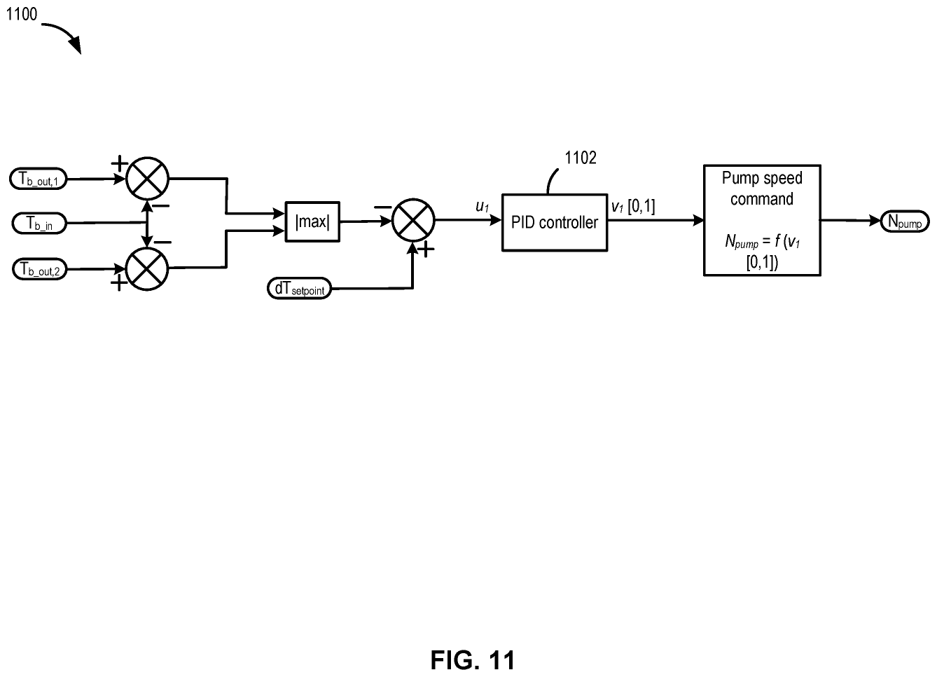

With reference now to FIG. 11, a block diagram of a control logic 1100 for a thermal management system (e.g., thermal management system 106, thermal management system 200, thermal management system 900) is illustrated, in accordance with various embodiments. Control logic 1100 may implement a method (e.g., method 1000 of FIG. 10) for managing thermal loads in an electric vehicle (e.g., a BEV and/or an FCEV). More particularly, control logic 1100 may be used for commanding a pump speed. With combined reference to FIG. 1, FIG. 9, and FIG. 10, control logic 1100 may receive a battery coolant temperature at an inlet of battery system (e.g., T_{b_in}) and a battery coolant temperature at an outlet of each battery 922a/922b of the battery system (e.g., T_{b_out,1}, T_{b_out,2}). In some exemplary embodiments, the battery coolant temperature at the inlet of the battery system may be measured upstream or downstream of pump 928. Control logic 1100 may be configured to determine differences between the battery coolant temperature at the outlet of each battery 922 of the battery system and the battery coolant temperature at the inlet of the battery system. Based on a maximum absolute value of these differences, control logic 1100 may further be configured to calculate a difference between a coolant temperature difference setpoint (e.g., dTₛₑₜₚₒᵢₙₜ) and the maximum absolute value difference, which may be used to obtain a first error value (u₁). The coolant temperature difference setpoint may be any suitable value. The first error value (u₁) may be minimized by a PID controller 1102 by adjusting and optimizing a first output variable (v₁) using proportional, integral, and/or derivative control actions. The first output variable (v₁) may be a value between 0 and 1. The first output variable (v₁) may then be used to compute a pump speed command (Nₚᵤₘₚ), for example using calibrated and/or empirical data. Pump 928 may then be commanded based on the pump speed command. While discussed herein primarily in relation to control logic for thermal management system 900, it should be appreciated the logic described herein could be applied to other thermal management systems, for example, thermal management system 200 described in relation to FIG. 2.

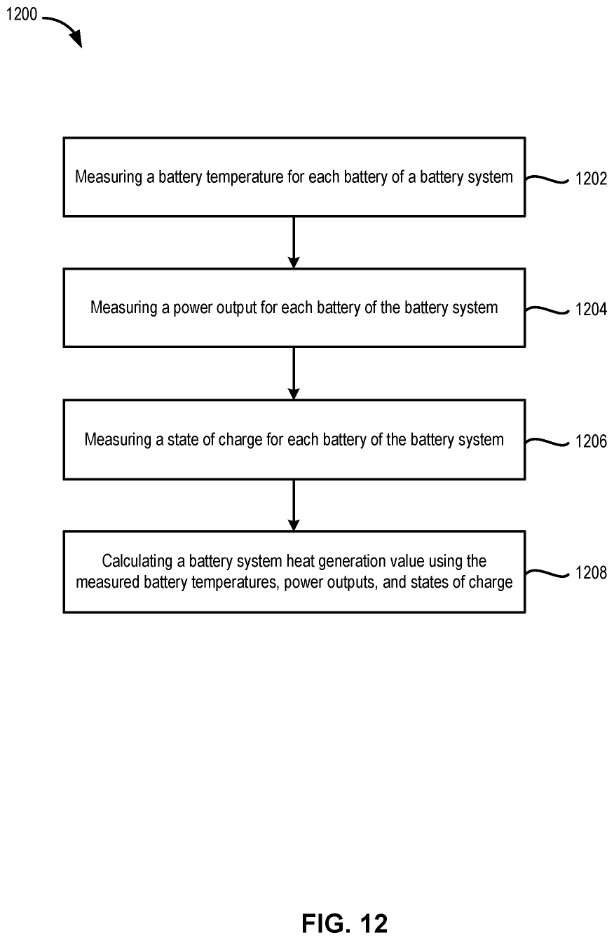

With reference now to FIG. 12, a flow chart illustrating a method 1200 of managing thermal loads in an electric vehicle (e.g., a BEV and/or an FCEV) is illustrated in accordance with various embodiments. Method 1200 may comprise measuring a battery temperature for each battery of a battery system (step 1202). Method 1200 may further comprise measuring a power output for each battery of the battery system (step 1204). Method 1200 may further comprise measuring a state of charge for each battery of the battery system (step 1206). Method 1200 may further comprise calculating a battery system heat generation value using the measured battery temperatures, power outputs, and states of charge (step 1208).

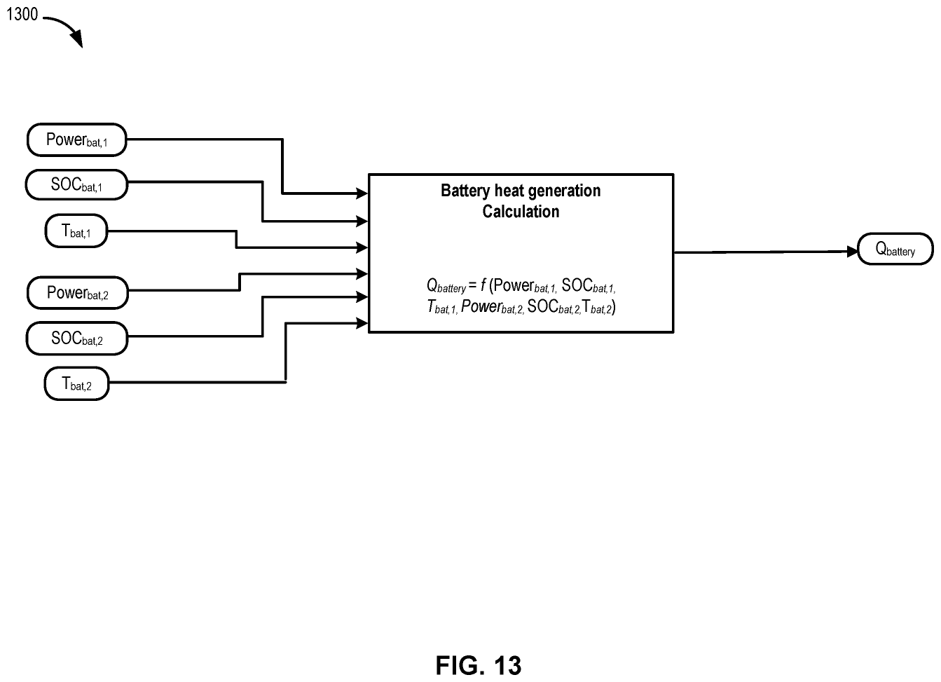

With reference now to FIG. 13, a block diagram of a control logic 1300 for a thermal management system (e.g., thermal management system 106, thermal management system 200, thermal management system 900) is illustrated, in accordance with various embodiments. Control logic 1300 may implement a method (e.g., method 1200 of FIG. 12) for managing thermal loads in an electric vehicle (e.g., a BEV and/or an FCEV). More particularly, control logic 1300 may be used for calculating a battery system heat generation value which can be used as an input for other control logics. With combined reference to FIG. 1, FIG. 9, and FIG. 12, control logic 1300 may receive a plurality of measured battery temperatures. These measured battery temperatures may be surface temperatures for each battery 922a/922b (for example, the temperature associated with an inner or outer surface of the battery enclosure). In some exemplary embodiments, the measured battery temperatures may be internal temperatures for each battery 922a/922b (for example, the temperature associated with a given battery cell, group of battery cells, battery module, or group of battery modules). Control logic 1300 may further receive a plurality of measured battery power outputs. In some exemplary embodiments, the plurality of measured battery power outputs may be based upon measured battery (pack) current and voltage values at a given time. In other embodiments, the measured battery power outputs may be based upon an average battery (pack) power output over a given time interval. In other embodiments, the measured power outputs may be based upon a power rating of each battery of the battery system. Control logic 1300 may further receive a plurality of measured battery states of charge. Each battery state of charge may be a percentage (for example, between 0 and 100%). Control logic 1300 may be configured to calculate a battery system heat generation value (Q_{battery}) using the measured battery temperatures, power outputs, and states of charge, for example, using a lookup table or polynomial expression. In turn, the battery system heat generation value may be stored in memory and used as an input for other control logic processes, for example, control logic 1500 described below. While discussed herein primarily in relation to control logic for thermal management system 900, it should be appreciated the control logic described herein could be applied to other thermal management systems, for example, thermal management system 200 described in relation to FIG. 2.

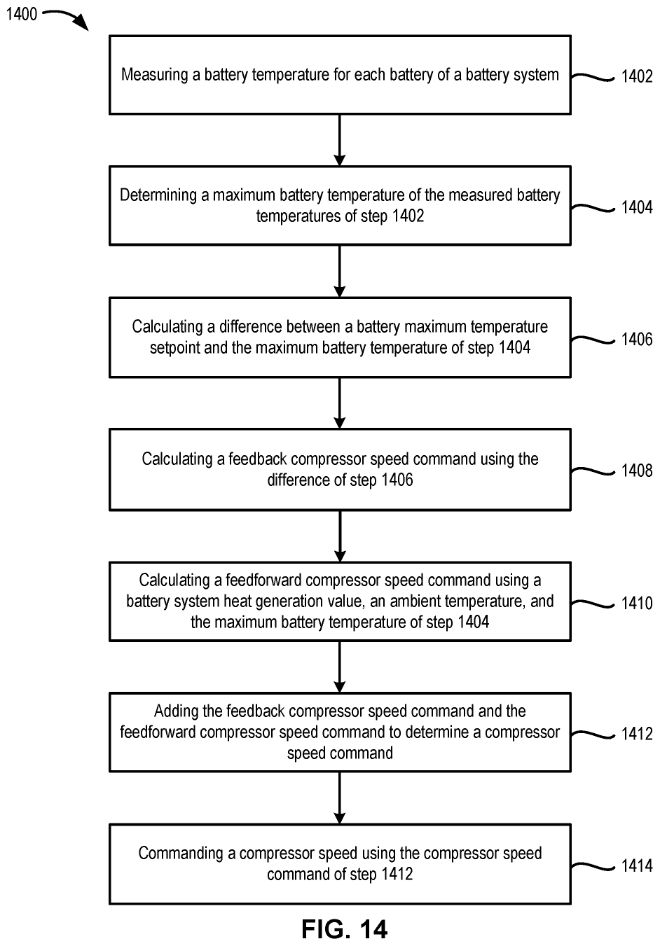

With reference now to FIG. 14, a flow chart illustrating a method 1400 of managing thermal loads in an electric vehicle (e.g., a BEV and/or an FCEV) is illustrated in accordance with various embodiments. Method 1400 may comprise measuring a battery temperature for each battery of a battery system (step 1402). Method 1400 may further comprise determining a maximum battery temperature of the measured battery temperatures of step 1402 (step 1404). Method 1400 may further comprise calculating a difference between a battery maximum temperature setpoint and the maximum battery temperature of step 1404 (step 1406). Method 1400 may further comprise calculating a feedback compressor speed command using the difference of step 1406 (step 1408). Method 1400 may further comprise calculating a feedforward compressor speed command using a battery system heat generation value, an ambient temperature, and the maximum battery temperature of step 1404 (step 1410). Method 1400 may further comprise adding the feedback compressor speed command and the feedforward compressor speed command to determine a compressor speed command (step 1412). Method 1400 may further comprise commanding a compressor speed using the compressor speed command of step 1412 (step 1414). In various embodiments, method 1400 further comprises heating a battery coolant using waste heat from the battery system to form a heated battery coolant and heating a refrigerant of a battery refrigeration loop by exchanging heat with the heated battery coolant.

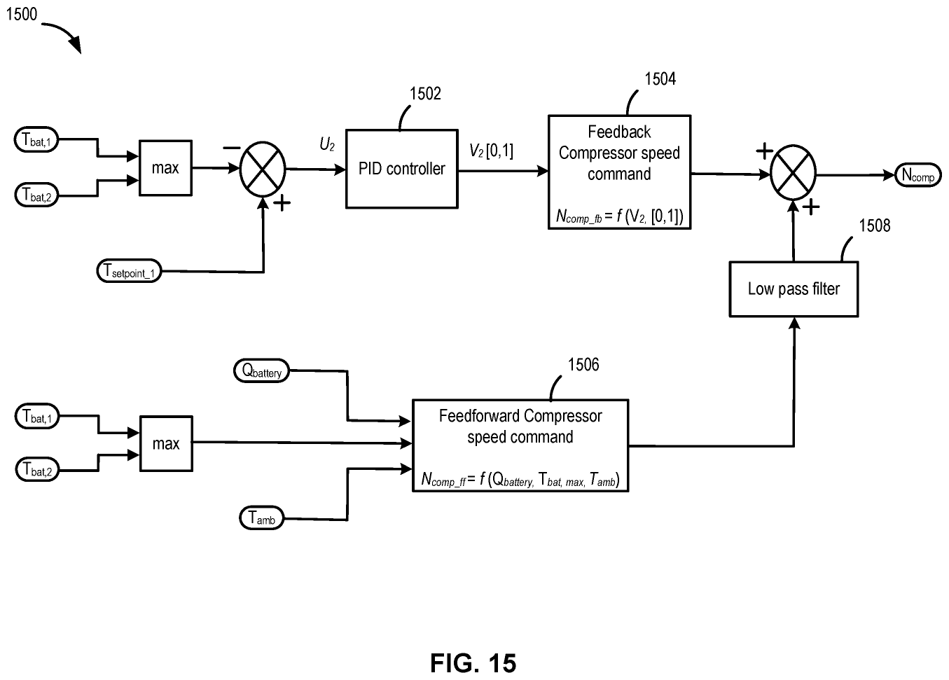

With reference now to FIG. 15, a block diagram of a control logic 1500 for a thermal management system (e.g., thermal management system 106, thermal management system 200, thermal management system 900) is illustrated, in accordance with various embodiments. Control logic 1500 may implement a method (e.g., method 1400 of FIG. 14) for managing thermal loads in an electric vehicle (e.g., a BEV and/or an FCEV). More particularly, control logic 1500 may be used for commanding a compressor speed. The compressor speed may be regulated using a combination of feedback control (PID) and feedforward control. Feedforward control tends to account for measured disturbances using a process module before the measured disturbances affect the process. Feedback control tends to compensate for unmeasured disturbances by providing corrective action after they affect the process. The combined feedback and feedforward control tends to ensure smooth performance of the compressor.

With combined reference to FIG. 1, FIG. 9, and FIG. 14, control logic 1500 may receive a plurality of battery temperatures. These measured battery temperatures may be surface temperatures for each battery 922a/922b (for example, the temperature associated with an inner or outer surface of the battery enclosure). In some exemplary embodiments, the measured battery temperatures may be internal temperatures for each battery 922a/922b (for example, the temperature associated with a given battery cell, group of battery cells, battery module, or group of battery modules). Control logic 1500 may be configured to determine a maximum battery temperature of the plurality of battery temperatures. Control logic 1500 may further be configured to calculate a difference between a battery maximum temperature setpoint (e.g., T_{setpoint_1}) and the maximum battery temperature. Using this difference, a second error value (u₂) may be obtained. The second error value (u₂) may be minimized by a PID controller 1502 (which may be the same controller as or a different controller from PID controller 1102) by adjusting and optimizing a second output variable (v₂) using proportional, integral, and/or derivative actions. The second output variable (v₂) may be a variable between 0 and 1. The second output variable (v₂) may then be used to compute a feedback compressor speed command 1504, for example using a lookup table or polynomial expression.

As discussed above, control logic 1500 may further calculate a feedforward compressor speed command 1506. More specifically, control logic 1500 may receive a battery system heat generation value (Q_{battery}), which may be calculated through method 1200 described above. Control logic 1500 may further receive an ambient temperature (T_{amb}). The ambient temperature (T_{amb}) may be based on external temperature sensor data (for example, data collected via a temperature sensor coupled to vehicle 100) or may be based upon data communicated to vehicle 100 from an external database (for example, a weather database). Using the battery system heat generation value (Q_{battery}), the ambient temperature (T_{amb}), and the maximum battery temperature (previously calculated to compute the feedback compressor speed command), control logic 1500 may compute the feedforward compressor speed command 1506, for example using a 3D lookup table or polynomial expression. A first order (or second order) low pass filter 1508 (also referred to as a lag filter) may be applied to the feedforward compressor speed command 1506 before it is added to the feedback compressor speed command 1504 to obtain the final compressor speed command (N_{comp}). Control logic 1500 may command the compressor 944 based on the compressor speed command (N_{comp}).

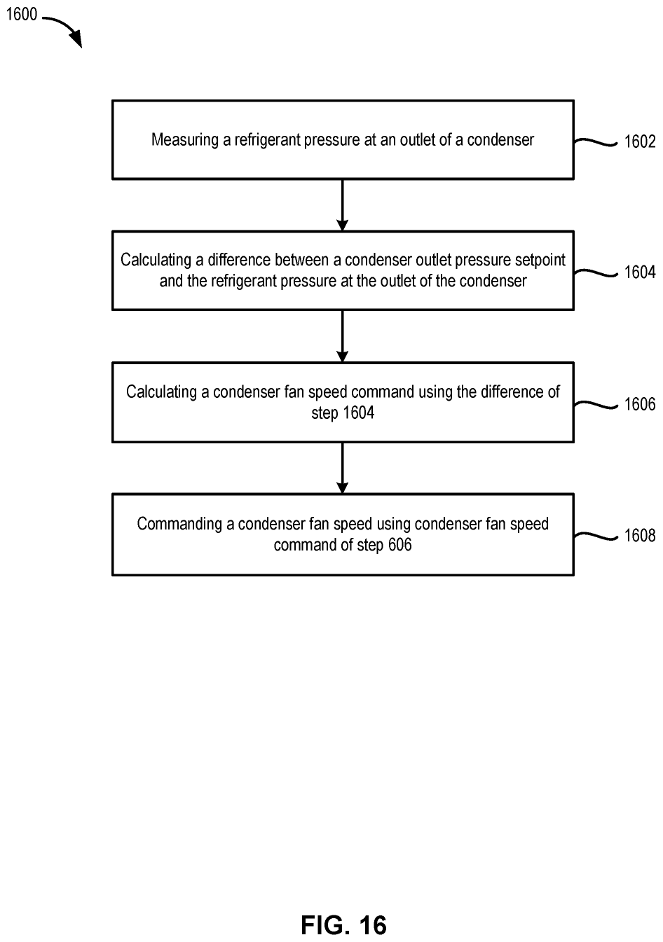

With reference now to FIG. 16, a flow chart illustrating a method 1600 of managing thermal loads in an electric vehicle (e.g., a BEV and/or an FCEV) is illustrated in accordance with various embodiments. Method 1600 may comprise measuring a refrigerant pressure at an outlet of a condenser (step 1602). Method 1600 may further comprise calculating a difference between a condenser outlet pressure setpoint and the refrigerant pressure at the outlet of the condenser (step 1604). Method 1600 may further comprise calculating a condenser fan speed command using the difference of step 1604 (step 1606). Method 1600 may further comprise commanding a condenser fan speed using the condenser fan speed command of step 1606 (step 1608). In various embodiments, method 1600 further comprises heating a battery coolant using waste heat from a battery system to form a heated battery coolant and heating a refrigerant of a battery refrigeration loop by exchanging heat with the heated battery coolant.

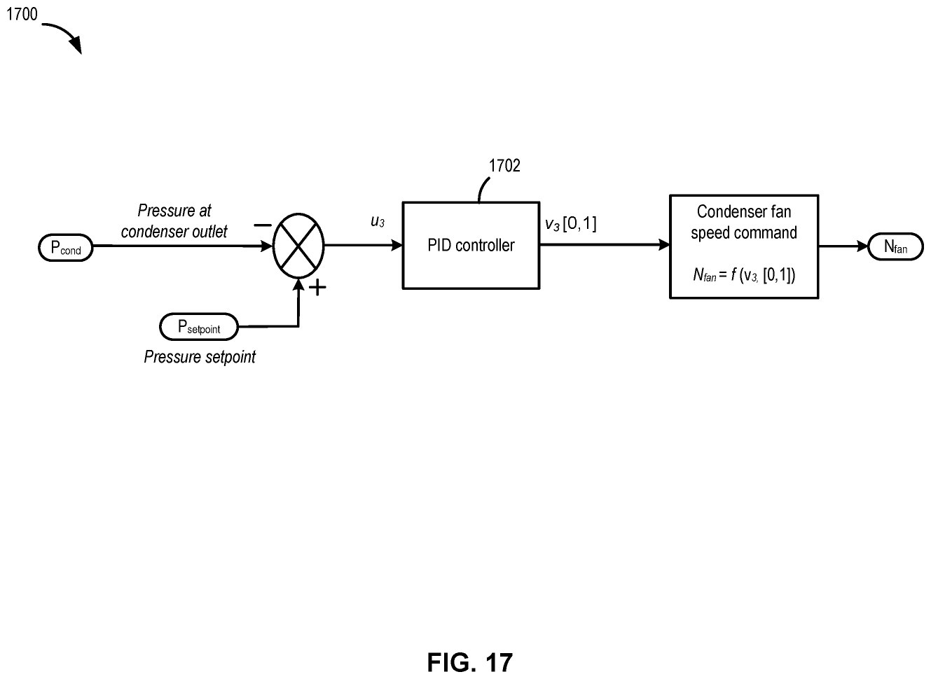

With reference now to FIG. 17, a block diagram of a control logic 1700 for a thermal management system (e.g., thermal management system 106, thermal management system 200, thermal management system 900) is illustrated, in accordance with various embodiments. Control logic 1700 may implement a method (e.g., method 1500 of FIG. 15) for managing thermal loads in an electric vehicle (e.g., a BEV and/or an FCEV). More particularly, control logic 1700 may be used for commanding a condenser fan speed. With combined reference to FIG. 1, FIG. 9, and FIG. 16, control logic 1700 may receive a measured refrigerant pressure (e.g., P_{cond}) at an outlet of condenser 944. Control logic 1700 may be configured to calculate a difference between a condenser outlet pressure setpoint (P_{cond,setpoint}) and the refrigerant pressure at the outlet of condenser 944. The condenser outlet pressure setpoint (P_{cond,setpoint}) may be any suitable pressure. Using the difference between the condenser outlet pressure setpoint cond,setpoint) and the refrigerant pressure at the outlet of condenser 944, a third error value (u₃) may be obtained. The third error value (u₃) may be minimized by a PID controller 1702 (which may be the same controller as or a different controller from PID controllers 1102, 1302) by adjusting and optimizing a third output variable (v₃) using proportional, integral, and/or derivative control actions. The third output variable (v₃) may be a value between 0 and 1. The third output variable (v₃) may then be used to compute a condenser fan speed command (N_{fan}), for example using a lookup table or an empirical correlation. Condenser 944 and fan 946 may then be commanded based on the condenser fan speed command. While discussed herein primarily in relation to control logic for thermal management system 900, it should be appreciated the control logic described herein could be applied to other thermal management systems, for example, thermal management system 200 described in relation to FIG. 2.

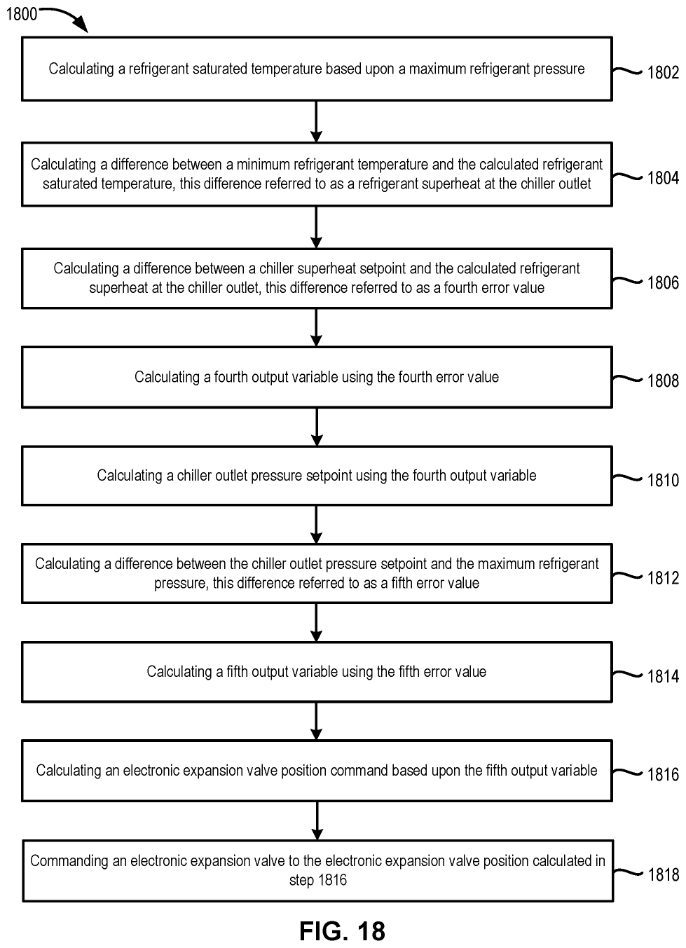

With reference now to FIG. 18, a flow chart illustrating a method 1800 of managing thermal loads in an electric vehicle (e.g., a BEV and/or an FCEV) is illustrated in accordance with various embodiments. Method 1800 may comprise calculating a refrigerant saturated temperature based upon a maximum refrigerant pressure (step 1802). Method 1800 may further comprise calculating a difference between a minimum refrigerant temperature and the calculated refrigerant saturated temperature, this difference referred to as a refrigerant superheat at the chiller outlet (step 1804). Method 1800 may further comprise calculating a difference between a chiller superheat setpoint and the calculated refrigerant superheat at the chiller outlet, this difference referred to as a fourth error value (u₄) (step 1806). Method 1800 may further comprise calculating a fourth output variable value (v₄) using the fourth error value (u₄) (step 1808). Method 1800 may further comprise calculating a chiller outlet pressure setpoint (P_{chill,setpoint}) using the fourth output variable (v₄) (step 1810). Method 1800 may further comprise calculating a difference between the chiller outlet pressure setpoint and the maximum refrigerant pressure, this difference referred to as a fifth error value (u₅) (step 1812). Method 1600 may further comprise calculating a fifth output variable (v₅) using the fifth error value (u₅) (step 1814). Method 1800 may further comprise calculating an electronic expansion valve position command based upon the fifth output variable (step 1816). Method 1800 may further comprise commanding an electronic expansion valve to the electronic expansion valve position calculated in step 1816 (step 1818). In various embodiments, method 1800 further comprises heating a battery coolant of a battery coolant loop utilizing waste heat from a battery to form a heat battery coolant. In various embodiments, method 1800 further comprises heating a refrigerant of a battery refrigeration loop by exchanging heat with the heated battery coolant.

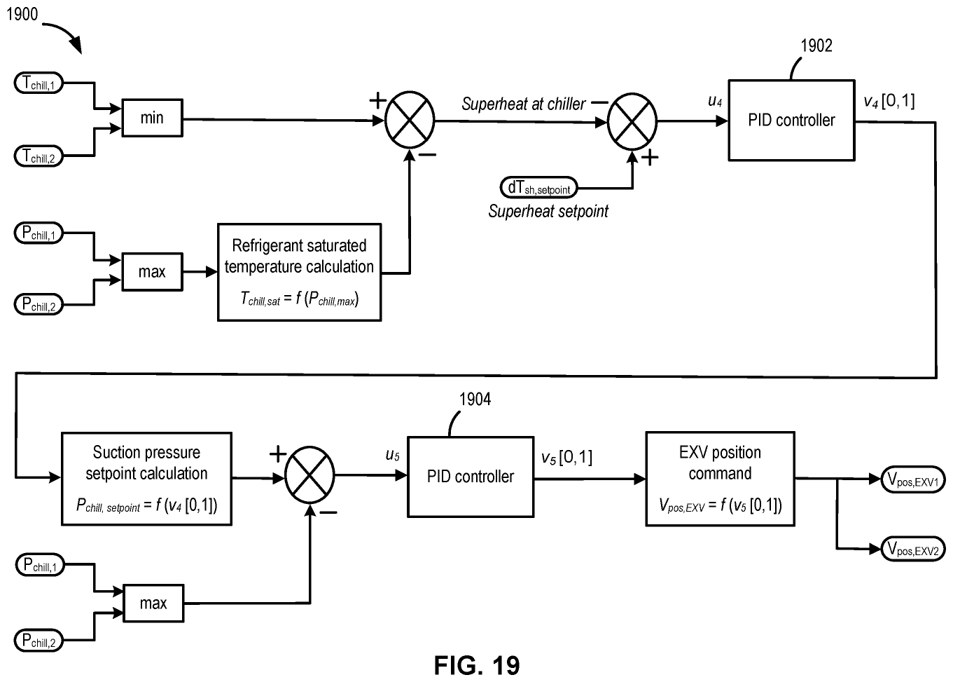

With reference now to FIG. 19, a block diagram of a control logic 1900 for a thermal management system (e.g., thermal management system 106, thermal management system 200, thermal management system 900) is illustrated, in accordance with various embodiments. Control logic 1900 may implement a method (e.g., method 1800 of FIG. 18) for managing thermal loads in an electric vehicle (e.g., a BEV and/or an FCEV). More particularly, control logic 1900 may be used for calculating one or more electronic expansion valve position commands. With combined reference to FIG. 1, FIG. 9, and FIG. 18, control logic 1900 may use a cascade PID controller to adjust electronic expansion valve positions based on refrigerant pressure and temperature measurements at the outlet of each chiller 924a/924b. The cascade controller may utilize two PID blocks in this case where the output variable from the first PID block is used as the desired setpoint (or reference) for the second PID block. In this manner, the effect of fluctuations or disturbances in measurements are dampened at the final output variable (EXV position). This may ensure smooth performance of the refrigeration system.

Control logic 1900 may receive a plurality of refrigerant temperatures (e.g., T_{chill,1} and T_{chill,2}), each measured at an outlet of the respective chiller 924a/924b. Control logic 1900 may receive a plurality of refrigerant pressures (e.g., P_{chill,1} and P_{chill,2}), each measured at the outlet of the respective chiller 924a/924b. In this regard, step 1802 of FIG. 18 may further include receiving, by control logic 1900, refrigerant temperatures (e.g., T_{chill,1} and T_{chill,2}) and refrigerant pressures (e.g., P_{chill,1} and P_{chill,2}) from temperature and pressure sensors, respectively located at respective outlets of each chiller 924a/924b. Control logic 1900 may calculate a refrigerant saturated temperature (T_{chill,sat}) based upon the maximum refrigerant pressure (e.g., the greater of T_{chill,1} and T_{chill,2}). The refrigerant saturated temperature (T_{chill,sat}) may be calculated using a lookup table or a polynomial expression. Control logic 1900 may calculate a difference between a minimum refrigerant temperature (e.g., the lesser of T_{chill,1} and T_{chill,2}) and the calculated refrigerant saturated temperature, this difference referred to as a refrigerant superheat at the chiller outlet. Stated differently, the refrigerant superheat at the chiller outlet may be defined as the difference between the measured temperature of the superheated refrigerant vapor and the saturation temperature at the same point. Control logic 1900 may calculate a difference between a chiller superheat setpoint (dT_{sh,setpoint}), for example 10° C., and the calculated refrigerant superheat at the chiller outlet, this difference referred to as a fourth error value (u₄). The difference between the desired chiller superheat setpoint and the calculated superheat may be used as the error value for a first PID controller 1902 (which may be the same controller as or a different controller from PID controllers 1102, 1502, 1702). The fourth error value (u₄) may be minimized by the first PID controller 1902 by adjusting and optimizing a fourth output variable (v₄). Stated differently, control logic 1900 may calculate fourth output variable (v₄) using the fourth error value (u₄). The fourth output variable (v₄) is then used to compute the chiller outlet (suction) pressure setpoint (P_{chill,setpoint}) via a lookup table or a polynomial expression. Stated differently, control logic 1900 may calculate the chiller outlet pressure setpoint (P_{chill,setpoint}) using the fourth output variable value (v₄).

For the second PID controller 1904 (which may be the same controller as or a different controller from PID controller 1102, 1502, 1702, 1902), the difference between the chiller outlet pressure setpoint (P_{chill,setpoint}) and the maximum of the two pressure measurements at the chiller outlets (e.g., the greater of P_{chill,1} and P_{chill,2}) is used as a fifth error value (u₅). Stated differently, control logic 1900 may calculate a difference between the chiller outlet pressure setpoint (P_{chill,setpoint}) and the maximum refrigerant pressure (e.g., the greater of P_{chill,1} and P_{chill,2}), this difference referred to as the fifth error value (u₅). The fifth error value (u₅) is minimized by the second PID controller 1904 by adjusting and optimizing a fifth output variable (v₅). Stated differently, control logic 1900 may calculate, using second PID controller 1904, the fifth output variable (v₅) using the fifth error value (u₅). The EXV position command (V_{pox,EXVx}) is finally calculated from the fifth output variable (v₅), for example using a lookup table or a polynomial expression. Stated differently, control logic 1900 may calculate an electronic expansion valve position command (V_{pos,EXVx}) based upon the fifth output variable (v₅). Each expansion valve 948a/948b may be commanded to the same position to avoid uneven mass flow rate, pressure, and temperature at the outlet of each chiller 924a/924b. The thermal management system may command the expansion valve 948 to operate at the electronic expansion valve position command (V_{pos,EXV1} and V_{pos,Exv2}) calculated using control logic 1900. While discussed herein primarily in relation to control logic for thermal management system 900, it should be appreciated the control logic described herein could be applied to other thermal management systems, for example, thermal management system 200 described in relation to FIG. 2.

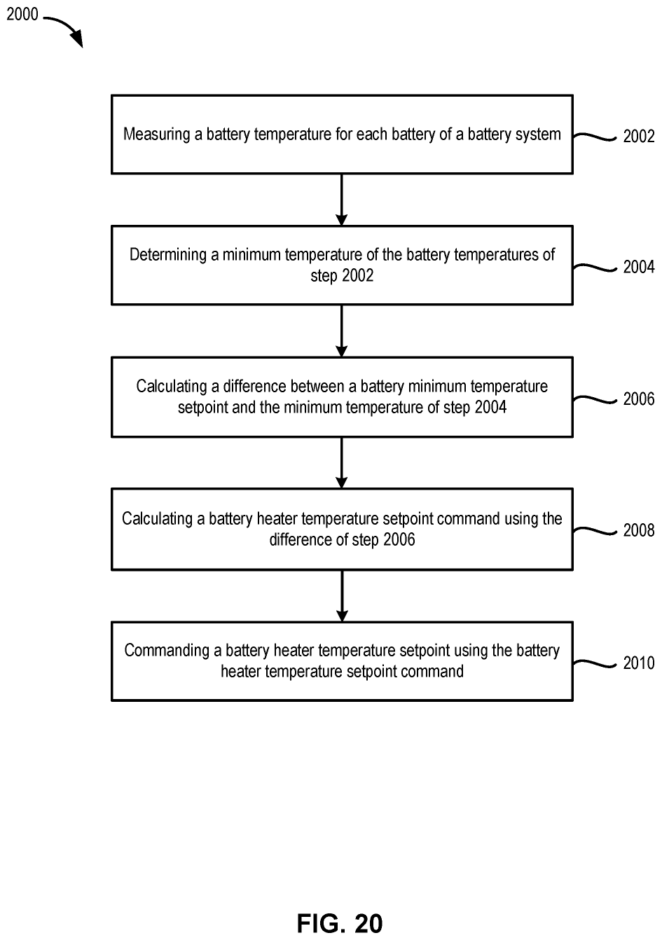

With reference now to FIG. 20, a flow chart illustrating a method 2000 of managing thermal loads in an electric vehicle (e.g., a BEV and/or an FCEV) is illustrated in accordance with various embodiments. Method 2000 may comprise measuring a battery temperature for each battery of a battery system (step 2002). Method 2000 may further comprise determining a minimum temperature of the battery temperatures of step 2002 (step 2004). Method 2000 may further comprise calculating a difference between a battery minimum temperature setpoint and the minimum temperature of step 2004 (step 2006). Method 2000 may further comprise calculating a battery heater temperature setpoint command using the difference of step 2006 (step 2008). Method 2000 may further comprise commanding a battery heater temperature setpoint using the battery heater temperature setpoint command (step 2010). In various embodiments, method 2000 further comprises heating a battery coolant using heat from the battery heater.

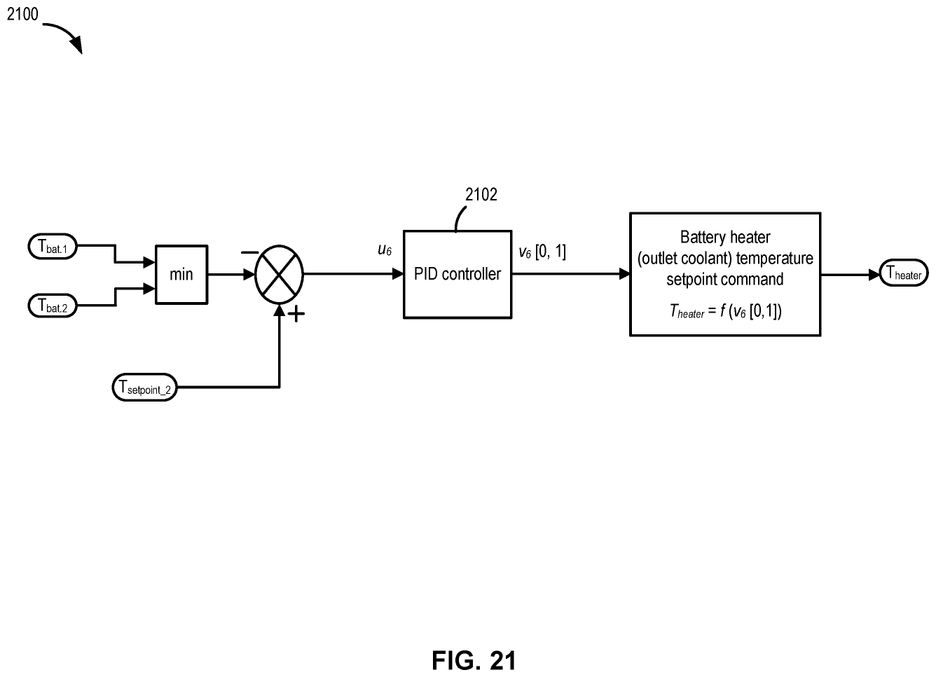

With reference now to FIG. 21, a block diagram of a control logic 2100 for a thermal management system (e.g., thermal management system 106, thermal management system 200, thermal management system 900) is illustrated, in accordance with various embodiments. Control logic 2100 may implement a method (e.g., method 2000 of FIG. 20) for managing thermal loads in an electric vehicle (e.g., a BEV and/or an FCEV). More particularly, control logic 2100 may be used for commanding a battery heater temperature setpoint. With combined reference to FIG. 1, FIG. 9, and FIG. 20, control logic 2100 may receive a plurality of measured battery temperatures (e.g., T_{bat,1}, T_{bat,2}). These measured battery temperatures may be surface temperatures for each battery 922a/922b (for example, the temperature associated with an inner or outer surface of the battery enclosure). In some exemplary embodiments, the measured battery temperatures may be internal temperatures for each battery 922a/922b (for example, the temperature associated with a given battery cell, group of battery cells, battery module, or group of battery modules). Control logic 2100 may be configured to determine a minimum battery temperature of the plurality of battery temperatures. Control logic 2100 may further be configured to calculate a difference between a battery minimum temperature setpoint (e.g., T_{setpoint_2}) and the minimum battery temperature. Using this difference, a sixth error value (u₆) may be obtained. The sixth error value (u₆) may be minimized by a PID controller 2102 (which may be the same controller as or a different controller from PID controller 1102, 1502, 1702, 1902, 1904) by adjusting and optimizing a sixth output variable (v₆) using proportional, integral, and/or derivative control actions. The sixth output variable (v₆) may be a variable between 0 and 1. The sixth output variable (v₆) may then be used to compute the battery heater temperature setpoint command (Tₕₑₐₜₑᵣ), for example using a lookup table or polynomial expression. Battery heater 964 may then be commanded based on the battery heater temperature setpoint command (Tₕₑₐₜₑᵣ). While discussed herein primarily in relation to control logic for thermal management system 900, it should be appreciated the control logic described herein could be applied to other thermal management systems, for example, thermal management system 200 described in relation to FIG. 2.

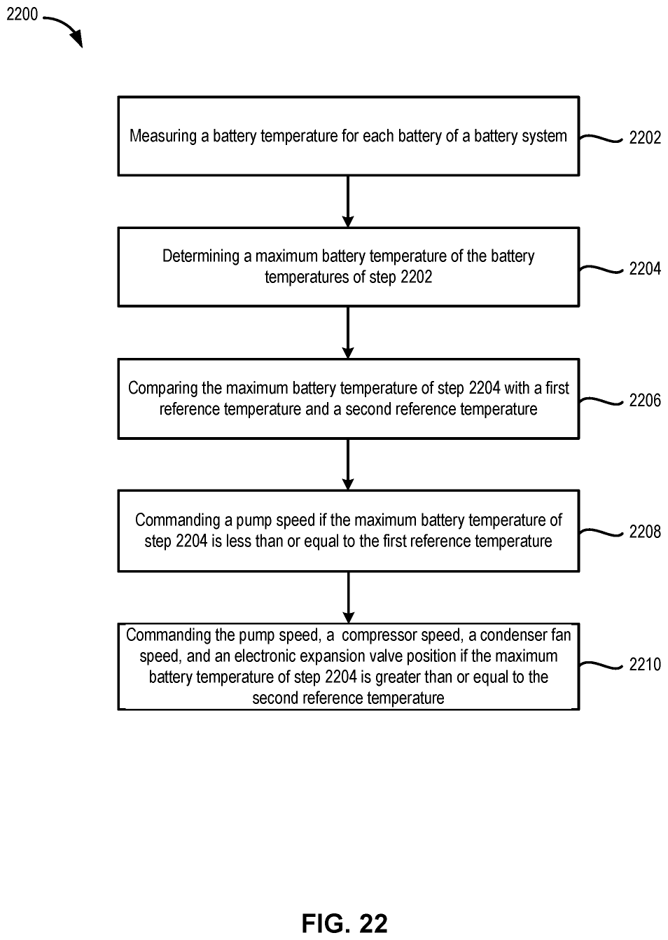

With reference now to FIG. 22, a flow chart illustrating a method 2200 of managing thermal loads in an electric vehicle (e.g., a BEV and/or an FCEV) is illustrated in accordance with various embodiments. Method 2200 may comprise measuring a battery temperature for each battery of a battery system (step 2202). Method 2200 may further comprise determining a maximum battery temperature of the battery temperatures of step 2202 (step 2204). Method 2200 may further comprise comparing the maximum battery temperature of step 2204 with a first reference temperature and a second reference temperature (step 2206). Method 2200 may further comprise commanding a pump speed if the maximum battery temperature of step 2204 is determined to be less than or equal to the first reference temperature (step 2208). Method 2200 may further comprise commanding the pump speed, a compressor speed, a condenser fan speed, and an electronic expansion valve position if the maximum battery temperature of step 2204 is determined to be greater than or equal to the second reference temperature (step 2210).

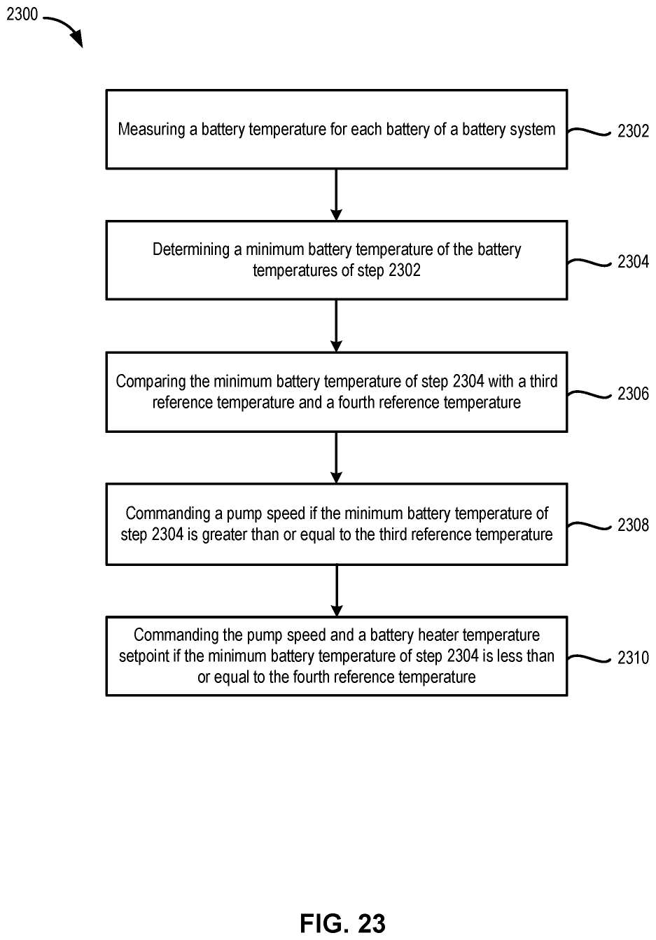

With reference now to FIG. 23, a flow chart illustrating a method 2300 of managing thermal loads in an electric vehicle (e.g., a BEV and/or an FCEV) is illustrated in accordance with various embodiments. Method 2300 may comprise measuring a battery temperature for each battery of a battery system (step 2302). Method 2300 may further comprise determining a minimum battery temperature of the battery temperatures of step 2302 (step 2304). Method 2300 may further comprise comparing the minimum battery temperature of step 2304 with a third reference temperature and a fourth reference temperature (step 2306). Method 2300 may further comprise commanding a pump speed if the minimum battery temperature of step 2304 is determined to be greater than or equal to the third reference temperature (step 2308). Method 2300 may further comprise commanding the pump speed and a battery heater temperature setpoint if the minimum battery temperature of step 2308 is determined to be less than or equal to the fourth reference temperature (step 2310).

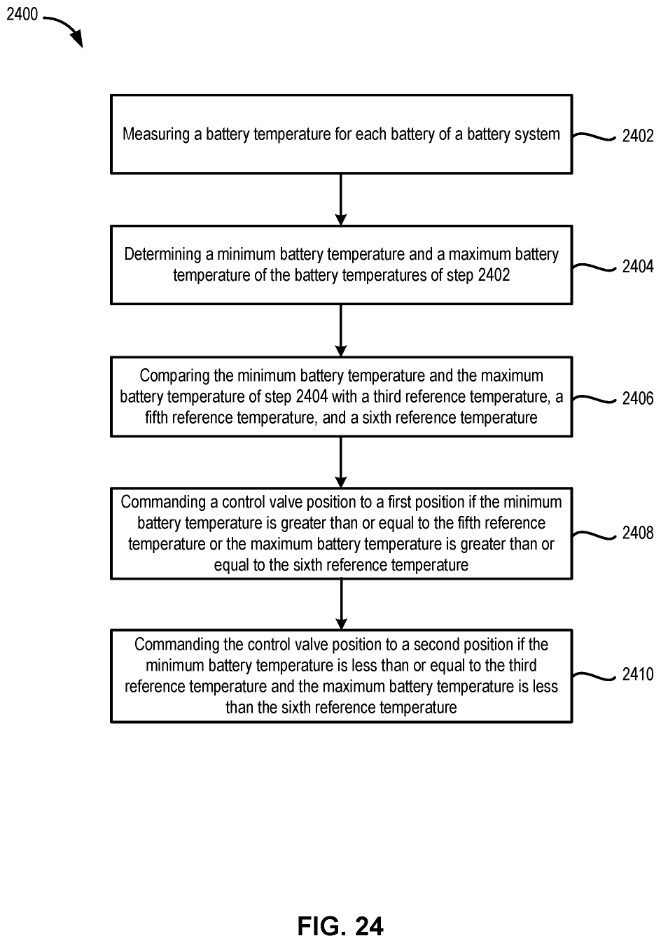

With reference now to FIG. 24, a flow chart illustrating a method 2400 of managing thermal loads in an electric vehicle (e.g., a BEV and/or an FCEV) is illustrated in accordance with various embodiments. Method 2400 may comprise measuring a battery temperature for each battery of a battery system (step 2402). Method 2400 may further comprise determining a minimum battery temperature and a maximum battery temperature of the battery temperatures of step 2402 (step 2404). Method 2400 may further comprise comparing the minimum battery temperature and the maximum battery temperature of step 2404 with a third reference temperature, a fifth reference temperature, and a sixth reference temperature (step 2406). Method 2400 may further comprise commanding a control valve position to a first position if the minimum battery temperature is greater than or equal to the fifth reference temperature or the maximum battery temperature is greater than or equal to the sixth reference temperature (step 2408). Method 2400 may further comprise commanding the control valve position to a second position if the minimum battery temperature is less than or equal to the third reference temperature and the maximum battery temperature is less than the sixth reference temperature (step 2410). In various embodiments, method 2400 may further comprise heating a battery coolant using heat from a battery heater.

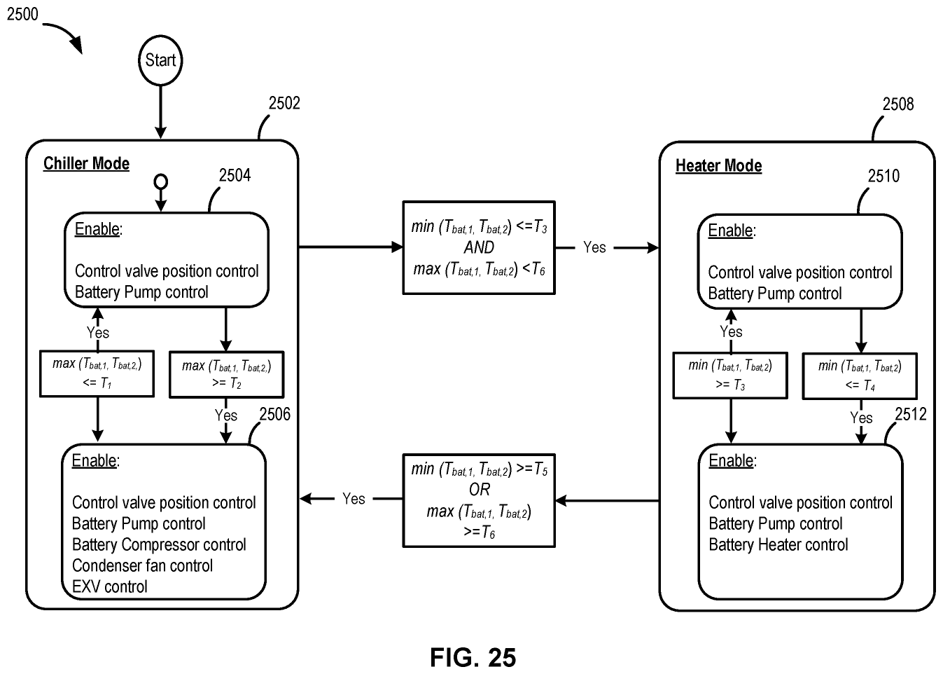

With reference now to FIG. 25, a block diagram of a control logic 2500 for a thermal management system (e.g., thermal management system 106, thermal management system 200, thermal management system 900) is illustrated, in accordance with various embodiments. Control logic 2500 may implement one or more methods (e.g., method 2200 of FIG. 22, method 2300 of FIG. 23, method 2400 of FIG. 24) for managing thermal loads in an electric vehicle (e.g., a BEV and/or an FCEV). More particularly, control logic 2500 may be used for switching between chiller modes, switching between heater modes, and switching between chiller and heater modes. With combined reference to FIG. 1, FIG. 9, and FIGS. 22-24, control logic 2500 may command the thermal management system (e.g., thermal management system 106, thermal management system 200, thermal management system 900) to begin in a chiller mode 2502, and more particularly, a first chiller mode 2504. Stated otherwise, control logic 2500 may be configured such that the default setting for the thermal management system is to circulate the battery coolant through battery refrigeration loop 940 while bypassing battery heater loop 960, for example, during vehicle startup. In other words, control logic 2500 may be configured to initially implement method 2200. Control logic 2500 may command a control valve position of control valve 930 to a first position (consistent with method 2400). In some exemplary embodiments, the first position may be a percentage, for example 0%, where 0% means control valve 930 is configured to direct all of the battery coolant to battery refrigeration loop 940 and 100% means control valve 930 is configured to direct all of the battery coolant to battery heater loop 960.

Initially, control logic 2500 may enable the first chiller mode 2504 and may command a pump speed (e.g., Nₚᵤₘₚ) of pump 928 by implementing method 1000 discussed above. Control logic 2500 may also receive a plurality of measured battery temperatures (e.g., T_{bat,1}, T_{bat,2}). These measured battery temperatures may be surface temperatures for each battery 922a/922b (for example, the temperature associated with an inner or outer surface of the battery enclosure). In some exemplary embodiments, the measured battery temperatures may be internal temperatures for each battery 922a/922b (for example, the temperature associated with a given battery cell, group of battery cells, battery module, or group of battery modules). Control logic 2500 may be configured to determine a maximum battery temperature of the measured battery temperatures. Control logic 2500 may further be configured to compare the maximum battery temperature with a first reference temperature (e.g., T₁) and a second reference temperature (e.g., T₂). The various reference temperatures (i.e., T₁, T₂, T₃, T₄, T₅, T₆) discussed herein are denoted as such for identification purposes only and the numbering of the reference temperatures is not necessarily related to the sequential or quantitative characteristics of the reference temperatures. In some exemplary embodiments, the first reference temperature may be 33° C. and the second reference temperature may be 34° C., however, the first reference temperature and the second reference temperature may be any suitable predetermined temperature. Control logic 2500 may command the pump speed (Nₚᵤₘₚ) of pump 928 by implementing method 1000 (using control logic 1100) if the maximum battery temperature is determined to be less than or equal to the first reference temperature.

Alternatively, control logic 2500 may enable a second chiller mode 2506 if the maximum battery temperature is determined to be greater than or equal to the second reference temperature. Second chiller mode 2506 may be configured to provide more cooling capacity than first chiller mode 2504. Second chiller mode 2506 may be configured to actively cool battery 922 by enabling and optimizing battery refrigeration loop 940. More specifically, if the maximum battery temperature is determined to be greater than or equal to the second reference temperature, control logic 2500 may command the pump speed (Nₚᵤₘₚ) of pump 928 by implementing method 1000 (using control logic 1100), command a compressor speed (Nₚᵤₘₚ) of compressor 942 by implementing method 1200 (using control logic 1300), command a condenser fan speed of condenser 944/fan 946 (N_{fan}) by implementing method 1400 (using control logic 1500), and command an electric expansion valve position (V_{pos,EXV1} and V_{pos,EXV2}) by implementing method 1600 (using control logic 1700). Control logic 2500 may be configured to continually or periodically compare the maximum battery temperature with the first reference temperature and the second reference temperature to switch between first chiller mode 2504 and second chiller mode 2506 as required. In such a way, sufficient cooling may be provided to battery 922 without incurring efficiency losses resulting from unnecessary operation of battery refrigeration loop 940. While discussed herein primarily in relation to control logic for thermal management system 900, it should be appreciated the control logic described herein could be applied to other thermal management systems, for example, thermal management system 200 described in relation to FIG. 2.

In some exemplary embodiments, control logic 2500 may be further configured to implement method 2300 such that the thermal management system (e.g., thermal management system 106, thermal management system 200, thermal management system 900) heats battery 922 rather than cools battery 922. Stated otherwise, control logic 2500 may enable a heater mode 2508 as opposed to chiller mode 2502. With focus on FIGS. 21 and 23, control logic 2300 may command the control valve position of control valve 930 to a second position (consistent with method 2200). In some exemplary embodiments, the second position may be a percentage, for example 100%, where 100% means control valve 930 is configured to direct all of the battery coolant to battery heater loop 960 and 0% means control valve is configured to direct all of the battery coolant to battery refrigeration loop 940.

Control logic 2500 may initially enable a first heater mode 2510 when heater mode 2508 is enabled. Stated otherwise, control logic 2500 may be configured such that the first heater mode 2510 is the default heater mode unless certain conditions (as discussed in relation to method 2300) are met. Initially, control logic 2500 may enable the first heater mode 2510 and may command a pump speed (e.g., Nₚᵤₘₚ) of pump 928 by implementing method 1000 discussed above. Control logic 2500 may also receive a plurality of measured battery temperatures (e.g, T_{bat,1}, T_{bat,2}). These measured battery temperatures may be surface temperatures for each battery 922a/922b (for example, the temperature associated with an inner or outer surface of the battery enclosure). In some exemplary embodiments, the measured battery temperatures may be internal temperatures for each battery 922a/922b (for example, the temperature associated with a given battery cell, group of battery cells, battery module, or group of battery modules). Control logic 2500 may be configured to determine a minimum battery temperature of the measured battery temperatures. Control logic 2500 may be further configured to compare the minimum battery temperature with a third reference temperature (e.g., T₃) and a fourth reference temperature (e.g., T₄). In some exemplary embodiments, the third reference temperature may be 30° C. and the fourth reference temperature may be 29° C., however, the third reference temperature and the fourth reference temperature may be any suitable predetermined temperature. In some exemplary embodiments, the third reference temperature and the fourth reference temperature are less than the first reference temperature and the second reference temperature. Control logic 2500 may command the pump speed (Nₚᵤₘₚ) of pump 928 by implementing method 1000 (using control logic 1100) if the minimum battery temperature is determined to be greater than or equal to the third reference temperature.

Alternatively, control logic 2500 may enable a second heater mode 2512 if the minimum battery temperature is determined to be less than or equal to the fourth reference temperature. Second heater mode 2512 may be configured to provide more heating capacity than first heater mode 2510. Second heater mode 2512 may be configured to actively heat battery 922 by enabling and optimizing battery heater 964. More specifically, if the minimum battery temperature is determined to be less than or equal to the fourth reference temperature, control logic 2500 may command a battery heater temperature setpoint (Tₕₑₐₜₑᵣ) of battery heater 964 by implementing method 1800 (using control logic 1900). Control logic 2500 may be configured to continually or periodically compare the minimum battery temperature with the third reference temperature and the fourth reference temperature to switch between first heater mode 2510 and second heater mode 2512 as required. In such a way, sufficient heating may be provided to battery 922 without incurring efficiency losses resulting from unnecessary operation of battery heater 964.

Control logic 2500 may further be configured to implement method 2400 to switch the thermal management system (e.g., thermal management system 106, thermal management system 200, thermal management system 900) between the chiller mode 2502 and heater mode 2508. More specifically, control logic 2500 may be configured to command the control valve position of control valve 930 depending on whether cooling or heating is desirable for battery 922. With focus on FIGS. 22 and 23, control logic 2500 may receive a plurality of measured battery temperatures (e.g., T_{bat,1}, T_{bat,2}). These measured battery temperatures may be surface temperatures for each battery 922a/922b (for example, the temperature associated with an inner or outer surface of the battery enclosure). In some exemplary embodiments, the measured battery temperatures may be internal temperatures for each battery 922a/922b (for example, the temperature associated with a given battery cell, group of battery cells, battery module, or group of battery modules). Control logic 2500 may be configured to determine a minimum battery temperature and a maximum battery temperature of the measured battery temperatures. Control logic 2500 may further be configured to compare the minimum battery temperature and the maximum battery temperature with a third reference temperature (e.g., T₃), a fifth reference temperature (e.g., T₅), and a sixth reference temperature (e.g., T₆). In some exemplary embodiments, the third reference temperature may be 30° C. (in other words, the same reference temperature as the third reference temperature discussed in relation to heater mode 2508), the fifth reference temperature may be 31° C., and the sixth reference temperature may be 35° C., however, the third reference temperature, the fifth reference temperature, and the sixth reference temperature may be any suitable predetermined temperature. In some exemplary embodiments, the fifth reference temperature is less than the first reference temperature, the second reference temperature, and the sixth reference temperature and greater than the third reference temperature and the fourth reference temperature. In some exemplary embodiments, the sixth reference temperature is greater than the first reference temperature, the second reference temperature, the third reference temperature, the fourth reference temperature, and the fifth reference temperature.

Control logic 2500 may command a control valve position of control valve 930 to a first position if the minimum battery temperature is greater than or equal to the fifth reference temperature or the maximum battery temperature is greater than or equal to the sixth reference temperature. In some exemplary embodiments, the first position may be a percentage, for example 0%, where 0% means control valve 930 is configured to direct all of the battery coolant to battery refrigeration loop 940 and 100% means control valve 930 is configured to direct all of the battery coolant to battery heater loop 960. Alternatively, control logic 2500 may command a control valve position of control valve 930 to a second position if the minimum battery temperature is less than or equal to the third reference temperature and the maximum battery temperature is less than the sixth reference temperature. In some exemplary embodiments, the second position may be a percentage, for example 100%. Control logic 2500 may be configured to continually or periodically compare the minimum battery temperature and the maximum battery temperature with the third reference temperature, the fifth reference temperature, and the sixth reference temperature to switch between chiller mode 2502 and heater mode 2508 as required. In such a way, sufficient heating or cooling may be provided to battery 922 based on need.

A vehicle battery thermal management system of the present disclosure may tend to reduce electronic expansion valve position fluctuations as a result of the compressor operation adjusting to the varying heat load caused by the variable coolant flow and battery cell temperatures. A vehicle battery thermal management system of the present disclosure tends to ensure smooth heating and refrigeration performance by limiting over/underreactions of various component outputs (i.e., valve position, compressor speed, etc.) in response to measured parameters, thereby leading to a more efficient thermal management system which may utilize less power input than traditional systems. Various benefits of a vehicle battery thermal management system of the present disclosure may be accomplished by utilizing pump speed control methods/logic, battery compressor speed control methods/logic, condenser fan speed control methods/logic, electronic expansion valve position control methods/logic, and/or battery heater control methods/logic.

More particularly, the pump control methods/logic of the present disclosure modulates the pump speed based on a temperature difference of the battery coolant at the outlet of each battery of the battery system and the inlet of the battery system to reach the desired cooling capacity. In this manner, the pump control methods/logic of the present disclosure may aid in preventing excessive or insufficient battery coolant flow rates which may result from measurements based on the battery coolant temperature at the inlet or outlet of the battery system only. Further, the pump speed control methods/logic of the present disclosure avoids excessive temperature gradients across battery pack (or packs) which could lead to localized overtemperature and thermal runaway events.

Still further, the compressor speed control methods/logic of the present disclosure modulates the compressor speed based upon the maximum battery temperature, battery system heat generation value, and ambient temperatures. Further, the compressor speed may be modulated based on a feedback portion and a feedforward portion to correlate the effect of measured disturbances on the controlled variable (compressor speed). The feedback compressor speed control reduces the control effort and total power consumption while maintaining the desired battery temperature. The feedforward compressor speed control reduces the likelihood of overcooling the battery pack (or packs) at low battery power levels and undercooling the same at high power levels.

Still further, the condenser fan speed control methods/logic of the present disclosure modulates the condenser fan speed based on the refrigerant pressure at the outlet of the condenser to reach the desired cooling capacity. In this manner, the condenser fan speed control methods/logic of the present disclosure may aid in preventing excessive fan speed fluctuations resulting from measured coolant and/or battery temperatures and will improve heat rejection efficiency and optimize power consumption at all operating conditions.

Still further, the electronic expansion valve position control methods/logic of the present disclosure modulates the electronic expansion valve position to maintain a desired superheat to ensure consistent operation and cooling of the battery compressor, in accordance with various embodiments. In this manner, electronic expansion valve position control methods/logic tends to reduce position fluctuations caused by external disturbances or noise in measurements; pressure can change quickly in a refrigeration system, it is important to not react to high frequency changes. Accordingly, the electronic expansion valve position control methods/logic of the present disclosure may compensate for uneven refrigerant flow.

Still further, the battery heater control methods/logic of the present disclosure modulates the battery heater temperature setpoint based upon measured battery temperatures to heat the battery where necessary. Using battery temperatures rather than battery coolant temperatures as inputs for determining the battery temperature setpoint may allow for faster responses to battery temperature fluctuations, particularly in circumstances where the thermal mass of the battery is low. At the same time, the battery heater control methods/logic may eliminate excessive temperature setpoint adjustments, thereby ensuring smooth performance of the heating system. Further, the battery heater control methods/logic described herein will reduce battery temperature fluctuations and improve battery stress with dynamic heat loads.

### EXAMPLES

### Examples 1-8—Method of Managing Thermal Loads in an Electric Vehicle

In Example 1, a method of managing thermal loads in an electric vehicle comprises: commanding a position of a control valve, measuring a first battery temperature and a second battery temperature, determining a maximum battery temperature of the first battery temperature and the second battery temperature, comparing the maximum battery temperature with a first reference temperature and a second reference temperature, enabling a first chiller mode and controlling a pump speed if the maximum battery temperature is determined to be less than or equal to the first reference temperature, and enabling a second chiller mode and controlling the pump speed, a compressor speed, a condenser fan speed, and an electronic expansion valve position if the maximum battery temperature is determined to be greater than or equal to the second reference temperature.

In Example 2, the method of Example 1, wherein the first reference temperature is less than the second temperature.

In Example 3, the method of Example 1, wherein the maximum battery temperature is compared with the first reference temperature and the second reference temperature periodically or continuously to switch between the first chiller mode and the second chiller mode.

In Example 4, the method of Example 1, wherein commanding the position of the control valve comprises commanding the control valve to a first position from a second position.

In Example 5, the method of Example 4, wherein, in the first position, the control valve directs a battery coolant to a chiller of a battery refrigeration loop and bypasses a battery heater of a battery heater loop.

In Example 6, the method of Example 1, further comprising enabling the first chiller mode by controlling the pump speed if the maximum battery temperature is determined to be between the first reference temperature and the second reference temperature.

In Example 7, the method of Example 1, wherein the first battery temperature and the second battery temperature are based on at least one of an enclosure temperature, module temperature, and cell temperature.

In Example 8, the method of Example 1, wherein controlling the pump speed comprises measuring a battery coolant temperature at an inlet of a battery system and at an outlet of a first battery and a second battery and calculating differences between the battery coolant temperature at the outlet of the first battery and the second battery and the battery coolant temperature at the inlet of the battery system.

### Examples 9-15—Method of Managing Thermal Loads in an Electric Vehicle

In Example 9, a method of managing thermal loads in an electric vehicle comprises: commanding a position of a control valve, measuring a first battery temperature and a second battery temperature, determining a minimum battery temperature of the first battery temperature and the second battery temperature, comparing the minimum battery temperature with a third reference temperature and a fourth reference temperature, enabling a first heater mode and controlling a pump speed if the minimum battery temperature is determined to be greater than or equal to the third reference temperature, and enabling a second heater mode and controlling the pump speed and a battery heater temperature setpoint if the minimum battery temperature is determined to be less than or equal to the fourth reference temperature.

In Example 10, the method of Example 9, wherein the third reference temperature is greater than the fourth reference temperature.

In Example 11, the method of Example 9, wherein the minimum battery temperature is compared with the third reference temperature and the fourth reference temperature periodically or continuously to switch between the first heater mode and the second heater mode.

In Example 12, the method of Example 9, wherein commanding the position of the control valve comprises commanding the control valve to a second position from a first position.

In Example 13, the method of Example 12, wherein, in the second position, the control valve directs a battery coolant to a battery heater of a battery heater loop and bypasses a chiller of a battery refrigeration loop.

In Example 14, the method of Example 9, further comprising enabling the first heater mode and controlling the pump speed if the minimum battery temperature is determined to be between the third reference temperature and the fourth reference temperature.

In Example 15, the method of Example 9, wherein controlling the battery heater temperature setpoint comprises calculating a difference between a minimum battery temperature setpoint and the minimum battery temperature.

### Examples 16-20—Method of Managing Thermal Loads in an Electric Vehicle

In Example 16, a method of managing thermal loads in an electric vehicle comprises: measuring a first battery temperature and a second battery temperature, determining a minimum battery temperature and a maximum battery temperature of the first battery temperature and the second battery temperature, comparing the minimum battery temperature and the maximum battery temperature with a third reference temperature, a fifth reference temperature, and a sixth reference temperature, commanding a control valve to a first position and enabling a chiller mode if the minimum battery temperature is determined to be greater than or equal to the fifth reference temperature or the maximum battery temperature is determined to be greater than or equal to the sixth reference temperature, and commanding the control valve to a second position and enabling a heater mode of the minimum battery temperature is determined to be less than or equal to the third reference temperature and the maximum battery temperature is determined to be less than the sixth reference temperature.

In Example 17, the method of Example 16, wherein the third reference temperature is less than the fifth reference temperature and the fifth reference temperature is less than the sixth reference temperature.

In Example 18, the method of Example 16, wherein, in the first position, the control valve directs a battery coolant to a chiller of a battery refrigeration loop and bypasses a battery heater of a battery heater loop.

In Example 19, the method of Example 16, wherein, in the second position, the control valve directs a battery coolant to a battery heater of a battery heater loop and bypasses a chiller of a battery refrigeration loop.

In Example 20, the method of Example 16, wherein the minimum battery temperature and the maximum battery temperature are compared with the third reference temperature, the fifth reference temperature, and the sixth reference temperature periodically or continuously to switch between the chiller mode and the heater mode.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or disclosure, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of managing thermal loads in an electric vehicle, the method comprising:
heating, utilizing waste heat from a battery, a battery coolant of a battery coolant loop to form a heated battery coolant;
heating a refrigerant of a battery refrigeration loop by exchanging heat with the heated battery coolant;
measuring a first refrigerant temperature located at an outlet of a first chiller;
measuring a first refrigerant pressure located at the outlet of the first chiller; and
controlling a position of a first electronic expansion valve based upon the first refrigerant temperature and the first refrigerant pressure.

2. The method of claim 1, wherein the first electronic expansion valve is located at an inlet of the first chiller.

3. The method of claim 2, further comprising passing the refrigerant through the first chiller to exchange heat with the heated battery coolant, the first chiller is thermally coupled between the battery coolant loop and the battery refrigeration loop.

4. The method of claim 3, further comprising:
compressing the refrigerant of the battery refrigeration loop after heating the refrigerant;
condensing the refrigerant of the battery refrigeration loop after compressing the refrigerant; and
expanding the refrigerant of the battery refrigeration loop after condensing the refrigerant using the first electronic expansion valve.

5. The method of claim 4, further comprising:
measuring a second refrigerant temperature located at an outlet of a second chiller;
measuring a second refrigerant pressure located at the outlet of the second chiller; and
controlling a position of a second electronic expansion valve based upon:
a minimum value of the first refrigerant temperature and the second refrigerant temperature; and
a maximum value of the first refrigerant pressure and the second refrigerant pressure.

6. The method of claim 5, further comprising:
measuring a first battery temperature of the battery; and
calculating a coolant flow rate using the first battery temperature.

7. The method of claim 6, further comprising:
measuring a first battery coolant temperature located at a battery inlet; and
calculating a compressor speed command based upon the coolant flow rate, the first battery coolant temperature, and a battery coolant temperature setpoint.

8. A method of managing thermal loads in an electric vehicle, the method comprising:
heating, utilizing waste heat from a battery, a battery coolant of a battery coolant loop to form a heated battery coolant;
heating a refrigerant of a battery refrigeration loop by exchanging heat with the heated battery coolant;
measuring a coolant temperature located at a battery inlet;
calculating a difference between a coolant temperature setpoint and the coolant temperature;
calculating a compressor speed command using the difference and a normalized coolant flow rate; and
controlling a speed of a first compressor in the battery coolant loop based upon the compressor speed command.

9. The method of claim 8, further comprising:
calculating a condenser fan speed command using the compressor speed command; and
controlling a speed of a condenser fan in the battery refrigeration loop based upon the condenser fan speed command.

10. The method of claim 8, wherein calculating the compressor speed command using the difference and the normalized coolant flow rate comprises:
multiplying the difference and the normalized coolant flow rate to obtain an error value; and
performing a proportional-integral-derivative (PID) control using the error value to compute an output variable,
wherein the compressor speed command is calculated using at least one of a lookup table or a polynomial expression.

11. The method of claim 9, wherein the condenser fan speed command is calculated using at least one of a lookup table or a polynomial expression.

12. The method of claim 8, wherein the compressor speed command is calculated further based upon a coolant flow rate, the normalized coolant flow rate determined based upon the coolant flow rate.

13. A thermal management system for an electric vehicle, comprising:
a first battery;
a battery coolant loop thermally coupled to the first battery and comprising a first chiller and a first pump;
a battery refrigeration loop comprising the first chiller thermally coupled to a compressor and a first electronic expansion valve; and
a controller in electronic communication with the first electronic expansion valve, the controller configured to control a position of the first electronic expansion valve,
wherein the first chiller is configured to transfer waste heat from the first battery to a refrigerant of the battery refrigeration loop.

14. The thermal management system of claim 13, wherein the battery coolant loop further comprises a first check valve, a first shut-off valve, and an expansion tank.

15. The thermal management system of claim 14, wherein the first battery, the first chiller, the first pump, the first check valve, the first shut-off valve, and the expansion tank are thermally and fluidly coupled via a battery coolant line.

16. The thermal management system of claim 15, further comprising:
a first refrigerant pressure sensor configured to measure a first refrigerant pressure at an outlet of the first chiller;
a first refrigerant temperature sensor configured to measure a first refrigerant temperature at the outlet of the first chiller;
a first coolant temperature sensor configured to measure a first coolant temperature at an inlet of the first battery;
a second coolant temperature sensor configured to measure a second coolant temperature at an outlet of the first battery; and
a first battery temperature sensor configured to measure a first battery surface temperature,
wherein the controller is configured to control the position of the first electronic expansion valve based upon the first refrigerant temperature and the first refrigerant pressure.

17. The thermal management system of claim 16, wherein the battery coolant loop further comprises a second battery, a second pump, a second check valve, a second shut-off valve, and a second chiller,
wherein the first battery, the first pump, the first check valve, the first shut-off valve are coupled in parallel with the second battery, the second pump, the second check valve, and the second shut-off valve, and
the first chiller is coupled in parallel with the second chiller.

18. The thermal management system of claim 17, further comprising:
a second refrigerant pressure sensor configured to measure a second refrigerant pressure at an outlet of the second chiller;
a second refrigerant temperature sensor configured to measure a second refrigerant temperature at the outlet of the second chiller;
a third coolant temperature sensor configured to measure a third coolant temperature at an outlet of the second battery; and
a second battery temperature sensor configured to measure a second battery surface temperature,
wherein the controller is configured to control the position of the first electronic expansion valve based upon a minimum of the first refrigerant temperature and the second refrigerant temperature and a maximum of the first refrigerant pressure and the second refrigerant pressure.

19. The thermal management system of claim 18, wherein the battery refrigeration loop further comprises a condenser and a second electronic expansion valve.

20. The thermal management system of claim 14, wherein the controller utilizes a proportional-integral-derivative control for calculating an electronic expansion valve position command for controlling the position of the first electronic expansion valve.
